(19) United States
(12) Patent Application Publication
(10) Pub. No.: US 2004/0241718 A1
(43) Pub. Date: Dec. 2, 2004

(54) Stationary phase for use in capillary electrophoresis, capillary electrochromatography, microfluidics, and related methods

(75) Inventor: Linda B. McGown, Durham, NC (US)

Correspondence Address: JENKINS & WILSON, PA, 3100 TOWER BLVD, SUITE 1400, DURHAM, NC, 27707, US

(73) Assignee: Duke University

(21) Appl. No.: 10/783,564

(22) Filed: Feb. 20, 2004

Related U.S. Application Data
(60) Provisional application No. 60/449,457, filed on Feb. 21, 2003.

(51) Int. Cl. C12Q 1/68

(52) U.S. Cl. 435/6; 204/450

(57) ABSTRACT

Provided are microfluidics, capillary electrophoresis and electrochromatography matrices employing a gel of G-quartet forming nucleosides and/or oligonucleotides. Also provided are compositions and columns based upon the matrices, as well as methods for making and using the matrices, and methods employing the matrices, such as methods for detecting a target analyte in a mixture employing the matrices.

### CROSS-REFERENCE TO RELATED APPLICATION

This application is based on and claims priority to U.S. Provisional Patent Application Serial No. 60/449,457, filed Feb. 21, 2003, herein incorporated by reference in its entirety.

### TECHNICAL FIELD

The presently disclosed subject matter relates generally to matrix materials useful for capillary electrophoresis, capillary electrochromatography, and microfluidics, and more particularly to G-quartet-forming nucleoside compounds and oligonucleotides which define a guanosine gel matrix. Methods of employing the matrix materials in preparative and analytical applications are also disclosed.

Table of Abbreviations

| | |
|---|---|
| ABS | acrylonitrile-butadiene-styrene copolymer |
| APDs | avalanche photodiodes |
| AU | absorbance units |
| CE | capillary electrophoresis |
| CEC | capillary electrochromatography |
| CGE | capillary gel electrophoresis |
| CZE | capillary zone electrophoresis |
| DNA | deoxyribonucleic acid |
| DPSS | diode-pumped solid state |
| EC | electrochromatography |
| EOF | electroosmotic flow |
| ESI-MS | electrospray mass spectrometry |
| GG | G-gel |
| GMP | guanosine monophosphate |
| HeNe | helium-neon |
| HPLC | high performance liquid chromatography |
| M | molar (moles per liter) |
| MALDI-TOF-MS | Matrix Assisted Laser Desorption |
| | Ionization Time-of-Flight Mass |
| | Spectrometry |
| MS | mass spectrometry |
| NIH | National Institutes of Health |
| PAGE | polyacrylamide gel electrophoresis |
| PCR | polymerase chain reaction |
| PDMS | polydimethylsiloxanes |
| PMMA | polymethylmethacrylate |
| PMTs | photo-multiplier tubes |
| PVC | polyvinyl chloride |
| RNA | ribonucleic acid |
| RP-HPLC | reverse phase high performance liquid |
| | chromatography |
| Rₛ | resolution |
| UV | ultraviolet [light] |
| v/v | volume/volume [ratio] |

Amino Acid Abbreviations, Codes, and Functionally Equivalent Codons

| | | | |
|---|---|---|---|
| Amino Acid | 3-Letter | 1-Letter | Codons |

| | | | |
|---|---|---|---|
| Alanine | Ala | A | GCA GCC GCG GCU |
| Arginine | Arg | R | AGA AGG CGA CGC CGG CGU |
| Asparagine | Asn | N | AAC AAU |
| Aspartic Acid | Asp | D | GAC GAU |
| Cysteine | Cys | C | UGC UGU |
| Glutamic acid | Glu | E | GAA GAG |
| Glutamine | Gln | Q | CAA CAG |
| Glycine | Gly | G | GGA GGC GGG GGU |
| Histidine | His | H | CAC CAU |
| Isoleucine | Ile | I | AUA AUC AUU |
| Leucine | Leu | L | UUA UUG CUA CUC CUG CUU |
| Lysine | Lys | K | AAA AAG |
| Methionine | Met | M | AUG |
| Phenylalanine | Phe | F | UUC UUU |
| Proline | Pro | P | CCA CCC CCG CCU |
| Serine | Ser | S | ACG AGU UCA UCC UCG UCU |
| Threonine | Thr | T | ACA ACC ACG ACU |
| Tryptophan | Trp | W | UGG |
| Tyrosine | Tyr | Y | UAC UAU |
| Valine | Val | V | GUA GUC GUG GUU |

### BACKGROUND ART

Electrophoresis is one of the most widely used separation techniques in the biologically related sciences. In electrophoretic processes, molecular species such as peptides, proteins, and oligonucleotides (generally and collectively referred to as “analytes”) are separated by causing them to migrate at different rates in a separation medium under the influence of an electric field. The separation medium can be, for example, a buffer solution, or in some embodiments, a low to moderate concentration of an appropriate gelling agent, such as agarose or polyacrylamide. When a gel separation medium is used, separation of analytes is partly based on the molecular sizes of the analytes sieved by the gel matrix. In general, the rate of migration depends on the type of gel and the molecules being separated. In size exclusion gels, for example, larger molecules travel faster than smaller molecules.

There are various electrophoretic techniques known in the art that employ the general electrophoretic method. For example, capillary gel electrophoresis (CGE) has been widely applied as an analytical technique. In CGE, a sample is applied to a small diameter capillary tube containing a separating medium, typically agarose or polyacrylamide. A high voltage is applied along the tube, thereby causing the sample to migrate along the length of the capillary tube.

Capillary electrophoresis (CE) offers several advantages over other electrophoretic-based separation techniques. These advantages include, for example, the following: (i) capillaries have high surface-to-volume ratios which permit more efficient heat dissipation which, in turn, permit high voltages to be used for more rapid separations; (ii) the technique requires minimal sample volumes; (iii) high resolution of most analytes is attainable; and (iv) the technique is suited to automation (see e.g., Grossman & Colburn, 1992; Camilleri, 1993).

Due in part to these and other advantages, there has been great interest in applying CE to the separation of biomolecules, for example in protein isolation and identification operations and in nucleic acid analysis. The need for rapid and accurate separation of nucleic acids, particularly deoxyribonucleic acid (DNA), arises, in one example, in the analysis of polymerase chain reaction (PCR) products and DNA sequencing fragment analysis (see e.g., Drossman et al., 1990; Swerdlow & Gesteland, 1990; Huang et al., 1992; Williams, 1992).

A variation on a general electrophoretic method is electrochromatography (EC). Generally, in EC, retention of solute by some form of stationary retentive phase provides the selectivity for separation, as is the case for a normal chromatographic separation. However, in EC, the fluid-mediated transport of solute is via electroosmotic flow, which is provided by the support material that holds the retentive phase. The interest in EC stems in part from the beliefs that zone broadening is generally smaller because the flow profile is uniform, and that flow can be achieved with smaller particles. Uniform flow profiles and smaller particles can lead to higher resolution; this resolution can be desirable in complex analysis or in situations in which the zone width can be compromised to run at faster analysis time. Uniform flow profiles are in contrast with the parabolic flow profile found in pressure-driven flow from a pump-driven packed bed chromatographic system. In pressure-driven systems, small particles can cause large pressure drops in the packed bed and can lead to pump fatigue and shorter column lifetime.

In EC, as in other techniques that work by electrophoresis and/or electroosmosis, molecules migrate under the influence of an applied electric field. This current is proportional to the cross-sectional area of the column through which transport takes place. Thus, capillary-sized columns can be used in capillary electrochromatography (CEC) because a low cross-sectional column area produces the lowest amount of heat (which can adversely affect the integrity of the molecules to be separated and can reduce the separation efficiency, due to formation of viscosity gradients). Capillary-sized columns can also be desirable because the high surface area-to-volume ratio of capillaries allows heat to be dissipated at a faster rate than heat dissipation can be achieved with larger sized columns.

In one current approach for creating a stationary phase in a capillary for CEC and capillary chromatography, open tubular capillaries are employed. In this method, a stationary phase reagent (such as an aptamer) is covalently attached to the inner surface of a capillary to form a stationary phase monolayer. One drawback of this method is that solutes must diffuse to the surface in order to interact with the stationary phase.

In a second method, capillaries are packed with packing particles, such as silica microspheres that can be coated with a stationary phase reagent, such as an aptamer. This approach is commonly employed in high performance liquid chromatography (HPLC). However, unlike the wide stainless steel columns used in HPLC, it is difficult to devise a way to retain the packing particles in a narrow silica capillary. Thus, a drawback of this method is that typically a retaining frit must be installed in the capillary to retain the packing material within the capillary. This is not a trivial consideration, since frit design, fitting, and installation are not routine operations.

In addition to performing analytical and/or preparative techniques (e.g. separations) using columns, microfluidics devices can also be employed. For example, applications of microfluidics include, but are not limited to (a) the transportation and delivery of analytes and reagents; (b) the capture and recovery of target molecules, the removal of undesirable sample components, and the isolation and pre-concentration of analytes; and (c) hybridization detection, mutation analysis, affinity capture, and directed proteomics using matrices containing oligonucleotides such as hybridization probes, aptamers, and/or genetic DNA. As such, there is considerable overlap between the techniques of CE, CEC, and EC, and microfluidics, with microfluidics providing a platform for performing analytical and/or preparative manipulations that can be done analogously to capillary methods but on a small scale and with much less reagent usage.

Thus, an improved matrix material for use in capillary electrophoresis, capillary electrochromatography, general microfluidic applications, and related methods represents a long-felt and ongoing need in the art. This and other needs are addressed by the presently disclosed subject matter.

### SUMMARY

This Summary lists several embodiments of the presently disclosed subject matter, and in many cases lists variations and permutations of these embodiments. This Summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this Summary or not. To avoid excessive repetition, this Summary does not list or suggest all possible combinations of such features.

The presently disclosed subject matter provides a capillary electrophoresis and electrochromatography matrix comprising a gel comprising one or more G-quartet forming nucleosides or oligonucleotides. In one embodiment, the gel comprises a monolithic form. In one embodiment, the one or more G-quartet forming nucleosides and/or oligonucleotides comprise any monomeric nucleoside or nucleotide or guanine-rich oligomeric nucleic acid, and combinations thereof. In another embodiment, the one or more G-quartet forming nucleosides and/or oligonucleotides are present on a microfluidics chip. In one embodiment, the matrix further comprises an enzyme.

The presently disclosed subject matter also provides a capillary electrophoresis and electrochromatography matrix comprising beads embedded in a gel comprising one or more G-quartet forming nucleosides and/or oligonucleotides. In one embodiment, the beads are chromatography packing beads. In another embodiment, the beads are functionalized. In one embodiment, the beads are functionalized with a protein, an oligonucleotide, or a combination thereof. In one embodiment, the gel comprises a monolithic form. In one embodiment, the one or more G-quartet forming nucleosides and/or oligonucleotides are present on a microfluidics chip.

The presently disclosed subject matter also provides a capillary electrophoresis and electrochromatography column comprising: (a) a matrix comprising a gel comprising G-quartet forming nucleosides and/or oligonucleotides; and (b) a support. In one embodiment, the gel comprises a monolithic form. In another embodiment, the G-quartet forming nucleosides and/or oligonucleotides comprise one of a monomeric nucleoside or nucleotide, a guanine-rich oligomeric nucleic acid, and combinations thereof. In another embodiment, the matrix further comprises an enzyme. In yet another embodiment, the matrix further comprises a cell.

The presently disclosed subject matter also provides a method of isolating a target analyte from a mixture. In one embodiment, the method comprises (a) contacting a mixture known or suspected to comprise a target analyte with a matrix comprising a gel comprising one or more G-quartet forming nucleosides and/or oligonucleotides; and (b) eluting the target analyte from the matrix. In one embodiment, the gel comprises a monolithic form. In another embodiment, the one or more G-quartet forming nucleosides and/or oligonucleotides comprise one of a monomeric nucleoside or nucleotide, a guanine-rich oligomeric nucleic acid, and combinations thereof. In another embodiment, the one or more G-quartet forming nucleosides and/or oligonucleotides are present on a microfluidics chip. In another embodiment, the matrix comprises beads embedded in the gel comprising G-quartet forming nucleosides and/or oligonucleotides. In another embodiment, the beads are chromatography packing beads. In one embodiment, the beads are functionalized. In one embodiment, the beads are functionalized with a protein, an oligonucleotide, or a combination thereof. In one embodiment, the matrix further comprises an enzyme, and in another embodiment the matrix further comprises a cell.

The presently disclosed subject matter also provides a method of detecting a target analyte in a mixture. In one embodiment, the method comprises (a) contacting a mixture known or suspected to comprise a target analyte with a matrix comprising a gel comprising one or more G-quartet forming nucleosides and/or oligonucleotides; (b) washing the matrix under conditions sufficient to remove non-specifically bound material; and (c) detecting the target analyte bound to the matrix. In one embodiment, the target analyte is a nucleic acid present within the genome of a microbe. In one embodiment, the gel comprises a monolithic form. In another embodiment, the one or more G-quartet forming nucleosides and/or oligonucleotides are present on a microfluidics chip. In another embodiment, the matrix further comprises an enzyme. In still another embodiment, the method further comprises lysing a cell that comprises the target analyte.

The presently disclosed subject matter also provides a microfluidics device. In one embodiment, the microfluidics device comprises one or more G-quartet forming nucleosides and/or oligonucleotides. In one embodiment, the one or more G-quartet forming nucleosides and/or oligonucleotides comprise a monomeric nucleoside or nucleotide, a guanine-rich oligomeric nucleic acid, and combinations thereof. In one embodiment, the one or more G-quartet forming nucleosides and/or oligonucleotides are disposed in a channel present on the device.

The presently disclosed subject matter also provides a method of transporting a reagent on a microfluidics device. In one embodiment, the method comprises (a) providing a microfluidics device comprising one or more G-quartet forming nucleosides and/or oligonucleotides; (b) contacting the microfluidics device with the reagent; and (c) applying a force to the microfluidics device to transport the reagent on the microfluidics device. In one embodiment, the one or more G-quartet forming oligonucleotides comprise a monomeric nucleoside or nucleotide, a guanine-rich oligomeric nucleic acid, and combinations thereof. In another embodiment, the one or more G-quartet forming nucleosides and/or oligonucleotides are disposed in a channel present on the device. In one embodiment, the force is provided by a pump or by an electrical current. In one embodiment, the reagent is a nucleic acid molecule.

Accordingly, it is an object of the presently disclosed subject matter to provide a new matrix material for use in CE, CEC, and microfluidics. This object is achieved in whole or in part by the presently disclosed subject matter.

An object of the presently disclosed subject matter having been stated hereinabove, other objects will be evident as the description proceeds and as best described hereinbelow.

### BRIEF DESCRIPTION OF THE DRAWINGS

FIGS. 1-6 depict the results of separating two enantiomers of the drug propranolol, D-propranolol and L-propranolol, from a racemate of DL-propranolol using capillary zone electrophoresis (CZE), under various conditions. For each of these Figures the run conditions are as follows: the mobile phase is 25 mM potassium phosphate, pH 7.0 with 0.02 M KCl; 1 second hydrodynamic injection; 135 V/cm; 15° C.; unless otherwise indicated. Absorbance was detected at 214 nm and expressed as absorbance units (AU). For those Figures and Figure panels that have them, the insets in the upper right corners depict an expanded scale of the electropherogram shown, highlighting the elution windows indicated.

FIG. 1 depicts an electropherogram of 0.1 mg/ml DL-propranolol using a bare capillary. FIG. 1 shows that there is no resolution of the enantiomers, which co-elute at about 9 minutes.

FIG. 2 depicts an electropherogram under conditions identical to the run depicted in FIG. 1, except that 0.01 M 5′-GMP has been added to the mobile phase. As can be seen, partial resolution of the enantiomers is accomplished with the addition of the 5′-GMP. Since G-gels absorb below 300 nm, the presence of the 5′-GMP contributes a background to the signal across the electropherogram. The single peak eluting at about 12 minutes is a blank signal associated with changes in the gel phase upon injection of buffer, whether or not it contains propranolol.

FIG. 3 depicts three electropherograms of 0.05 mg/ml DL-propranolol in the presence of different concentrations of 5′-GMP. In the top panel, the 5′-GMP concentration was 0.01 M; in the middle panel, the 5′-GMP concentration was 0.02 M; and in the bottom panel, the 5′-GMP concentration was 0.05 M. Other run conditions are as in FIG. 2, except that the run was performed at 20° C. instead of 15° C. FIG. 3 demonstrates that under increasing 5′-GMP concentration, the resolution of the enantiomers improves, but the stability of the baseline decreases.

FIG. 4 depicts three electropherograms of 0.05 mg/ml DL-propranolol at different run temperatures. In the top panel, the run temperature was 15° C.; in the middle panel, the run temperature was 20° C.; and in the bottom panel, the run temperature was 25° C. Other run conditions were a mobile phase of 0.02 M 5′-GMP in 25 mM potassium phosphate, pH 7.0 with 0.02 M KCl; 1 second hydrodynamic injection; and 189 V/cm. FIG. 4 demonstrates that under increasing run temperature, the resolution of the enantiomers decreases, most likely due to a decrease in the chiral structure of the gel as it begins to lose its organization at higher temperatures.

FIG. 5 depicts three electropherograms of 0.05 mg/ml DL-propranolol under conditions of different electric field strength. In the top panel, the run was at 135 V/cm; in the middle panel, the run was at 189 V/cm; and in the bottom panel, the run was at 270 V/cm. Other run conditions were a mobile phase of 0.02 M 5′-GMP in 25 mM potassium phosphate, pH 7.0 with 0.02 M KCl; 1 second hydrodynamic injection; at 20° C. FIG. 5 demonstrates that under increasing electric field strength, the resolution of the enantiomers increases, most likely due to band broadening at lower field strengths as the sample plug spends increasing amounts of time in the capillary.

FIG. 6 depicts two electropherograms of 0.05 mg/ml DL-propranolol in the presence or absence of an organic additive. In the bottom panel, the run conditions were a mobile phase of 0.02 M 5′-GMP in 25 mM potassium phosphate, pH 7.0 with 0.02 M KCl; 1 second hydrodynamic injection; 189 V/cm; at 20° C. The top panel depicts identical run conditions except that 5% v/v 2-propanol was added to the mobile phase. FIG. 6 demonstrates that the addition of 2-propanol improves the quality of the baseline in the electropherogram. The effects on resolution are presented in Table 2.

FIG. 7 depicts an Ohm's Law plot of field strength vs. current in the presence or absence of 2-propanol. Run conditions were 0.02 M 5′-GMP in 25 mM potassium phosphate, pH 7.0 with 0.02 M KCl at 20° C. In each case, the field strength used for the enantiomeric separations is within the linear range of the plat and the generated currents are reasonable. Joule heating is therefore not expected to be a significant consideration for the 5′-GMP gel mobile phases.

FIG. 8 depicts the resolution (R_{S}) and migration times (taken at the midpoint between the two peaks) for nine consecutive separations of 0.05 mg/ml DL-propranolol on a single column. The average resolution is 2.2±0.1 (±4.5%) and the average migration time is 4.77±0.06 minutes (±1.3%). The fluctuations in resolution appear to be random, while there is a slight downward trend in migration time, particularly in the first 2-3 runs. The decrease in retention time might be due to modifications of the fresh capillary over the course of different runs, or effects of minor changes in ambient temperature on the gel mobile phase. Run conditions were 0.02 M 5′-GMP in 25 mM potassium phosphate, pH 7.0 with 0.02 M KCl; 1 second hydrodynamic injection; 270 V/cm; at 20° C.

FIGS. 9-12 schematically depict the capture and release of a molecular target/analyte by a G-gel that incorporates an oligonucleotide such as a hybridization probe or an aptamer that binds to the target oligonucleotide fragment for hybridization detection or analyte molecule in the case of aptameric recognition.

FIG. 9 is a schematic depiction of the reversible incorporation of oligonucleotides that have been extended at one end to include a string of guanines into the gel backbone.

FIG. 10 is a schematic depiction of hybridization of a target nucleic acid to a probe nucleic acid that has been incorporated into a G-gel.

FIGS. 11 and 12 schematically depict the capture and release of a molecular target (represented by the shaded ellipse) by a G-gel that incorporates an aptameric oligonucleotide to the target molecule.

FIG. 11 schematically depicts the situation where the melting temperature of the aptamer conformation is below that of the gel.

FIG. 12 schematically depicts the situation where the gel melts below the melting temperature of the aptamer conformation.

FIG. 13 is a schematic representation of an exemplary microfluidics system.

FIG. 14 is a schematic representation of an exemplary microfluidics device, in this case a microfluidics chip.

FIG. 15 is a schematic representation of a cross-sectional view of a microfluidics chip. Shown are the top and bottom components of the chip, along with the channel filled with a G-gel of the presently disclosed subject matter (shown as a shaded box).

### DETAILED DESCRIPTION

The presently disclosed subject matter will be now be described more fully hereinafter with reference to the accompanying Examples, in which representative embodiments of the presently disclosed subject matter are shown. The presently disclosed subject matter can, however, be embodied in different forms and should not be construed as limited to the embodiments set forth herein. Rather, these embodiments are provided so that this disclosure will be thorough and complete, and will fully convey the scope of the presently disclosed subject matter to those skilled in the art.

All of the patents (including published patent applications) and publications (including GENBANK® sequence references), which are cited herein, are hereby incorporated by reference in their entireties to the same extent as if each were specifically stated to be incorporated by reference. Any inconsistency between these patents and publications and the present disclosure shall be resolved in favor of the present disclosure.

In some embodiments, the presently disclosed subject matter comprises a monolithic stationary phase for use in capillary electrophoresis and capillary electrochromatography, as well as CE and CEC-related methods employing a stationary phase of the presently disclosed subject matter. In one embodiment, the stationary phase comprises G-quartet-forming nucleosides, nucleotides and/or oligonucleotides that define a gel matrix. This aspect of the presently disclosed subject matter takes advantage of the fact that guanosine compounds forms gels via the formation of G-quartet networks under certain conditions. See Gellert et al., 1962; Chantot et al., 1971; Guschlbauer et al., 1990. The presently disclosed subject matter can comprise a guanosine-rich gel adapted for analytical separations, such as the isolation of proteins and chiral compounds from a complex mixture, and for other analytical and preparative applications.

A matrix material (for example, a stationary phase, which can be a gel) of the presently disclosed subject matter can comprise guanine nucleosides, guanine nucleotides, guanine-rich oligonucleotides containing runs of guanine nucleotides (e.g., G quartet forming oligonucleotides), guanine-rich polynucleotides containing runs of guanine nucleotides (e.g., G quartet forming polynucleotides), and combinations thereof (collectively referred to herein as “gel-forming materials”; GFMs), in some embodiments formed in an aqueous buffer. The guanine nucleosides, guanine nucleotides, guanine-rich oligonucleotides containing runs of guanine nucleotides, guanine-rich polynucleotides containing runs of guanine nucleotides, and combinations thereof can also be derivatized or functionalized. In one embodiment, the aqueous buffer comprises a monovalent cation, for example potassium or sodium. In one embodiment, a matrix material can comprise GFMs. In another embodiment, a stationary phase can be formed in a capillary as a monolithic phase comprising GFMs. In a further aspect, the presently disclosed subject matter provides a guanosine-rich gel in which chromatographic packing beads are imbedded in order to immobilize the beads in a capillary column.

### I. Definitions

Unless otherwise defined, all technical and scientific terms used herein have the same meaning as commonly understood by one of ordinary skill in the art to which the presently disclosed subject matter pertains. For clarity of the present specification, certain definitions are presented hereinbelow.

Following long-standing patent law convention, the terms “a” and “an” mean “one or more” when used in this application, including the claims.

As used herein, the term “about,” when referring to a value or to an amount of mass, weight, time, volume, concentration, or percentage is meant to encompass variations of in one embodiment ±20%, in another embodiment ±10%, in another embodiment ±5%, in another embodiment ±1%, and in still another embodiment ±0.1% from the specified amount, as such variations are appropriate to perform the disclosed method.

As used herein, the terms “amino acid” and “amino acid residue” are used interchangeably and mean any of the twenty naturally occurring amino acids. An amino acid is formed upon chemical digestion (hydrolysis) of a polypeptide at its peptide linkages. The amino acid residues described herein are preferably in the “L” isomeric form. However, residues in the “D” isomeric form can be substituted for any L-amino acid residue, as long as the desired functional property is retained by the polypeptide. NH₂ refers to the free amino group present at the amino terminus of a polypeptide. COOH refers to the free carboxy group present at the carboxy terminus of a polypeptide. In keeping with standard polypeptide nomenclature abbreviations for amino acid residues are shown in tabular form presented hereinabove.

It is noted that all amino acid residue sequences represented herein by formulae have a left-to-right orientation in the conventional direction of amino terminus to carboxy terminus. In addition, the phrases “amino acid” and “amino acid residue” are broadly defined to include modified and unusual amino acids.

Furthermore, it is noted that a dash at the beginning or end of an amino acid residue sequence indicates a peptide bond to a further sequence of one or more amino acid residues or a covalent bond to an amino-terminal group such as NH₂ or acetyl or to a carboxy-terminal group such as COOH.

As used herein, the term “cell” refers not only to the particular subject cell (e.g., a living biological cell), but also to the progeny or potential progeny of such a cell. Because certain modifications can occur in succeeding generations due to either mutation or environmental influences, such progeny might not, in fact, be identical to the parent cell, but are still included within the scope of the term as used herein.

As used herein, the term “detecting” means confirming the presence of a target entity by observing the occurrence of a detectable signal, such as a radiologic or spectroscopic signal that will appear exclusively in the presence of the target entity.

As used herein, the term “functionalized” refers to the presence on a molecule of a reactive group that allows for the attachment of another molecule to it. For example, modified DNA can be covalently attached to a surface that has been functionalized with amino acids (Running & Urdea, 1990; Newton et al., 1993; Nikiforov & Rogers, 1995), carboxyl groups, (Zhang et al., 1991), epoxy groups (Eggers et al., 1994; Lamture et al., 1994), or amino groups (Rasmussen et al., 1991). Additionally, the term “functionalized” is also intended to refer to a matrix or a bead that comprises a molecule with a particular chemical or biological function. In this usage, a functionalized matrix or a functionalized bead is a matrix or a bead, respectively, to which a biological molecule has been attached. In one embodiment, a functionalized matrix comprises an enzyme (for example, a lysozyme, a nuclease, or a combination thereof). In another embodiment, a functionalized matrix comprises an oligonucleotide to which a microbial nucleic acid can bind. In another embodiment, a functionalized matrix comprises an oligonucleotide to which a target analyte can bind. In another embodiment, a functionalized bead comprises a bead to which an oligonucleotide, an enzyme, or a combination thereof has been attached.

As used herein, the term “G-gel”, and grammatical variants thereof, refers to a matrix (for example, a gel) that comprises a G-quartet forming material (for example, an oligonucleotide or 5′-GMP). As discussed in more detail herein, G-gels can be used as matrices for analytical and preparative separations.

As used herein, the term “hybridization” means the binding of a probe molecule, a molecule to which a detectable moiety has been bound, to a target analyte. Hybridization can include the pairing of substantially complementary nucleotide sequences (strands of nucleic acid) by the establishment of hydrogen bonds between complementary base pairs to form a duplex. Hybridization is a specific, i.e. non-random, interaction between two complementary polynucleotides.

As used herein, the term “interact” includes “binding” interactions and “associations” between molecules. Interactions can be, for example, protein-protein, protein-small molecule, protein-nucleic acid, and nucleic acid-nucleic acid in nature.

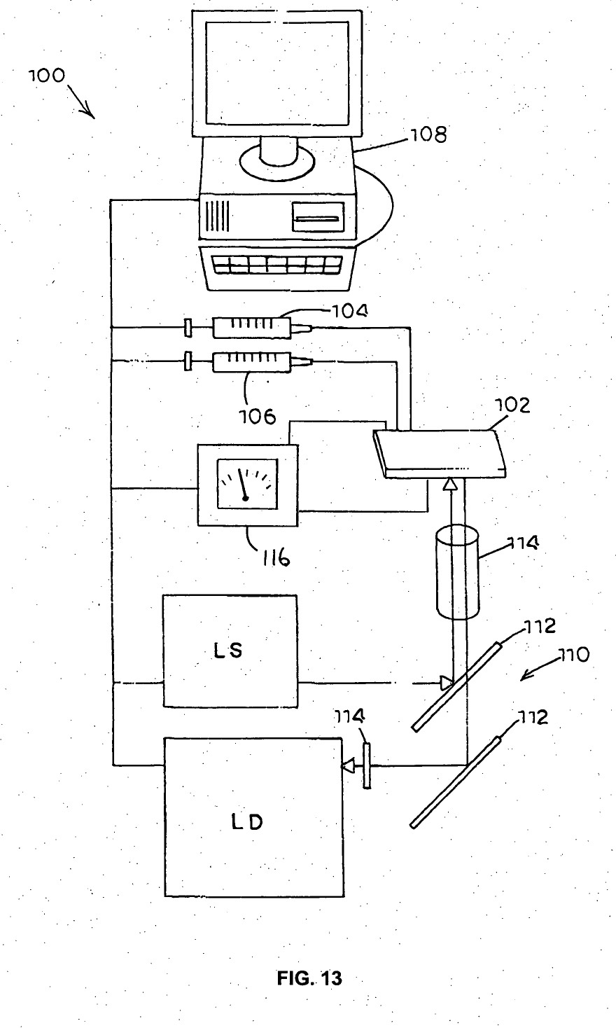

As used herein, the term “microfluidic chip,” “microfluidic device,” or “microfluidic system” generally refers to a chip, device, or system that can incorporate a plurality of interconnected channels or chambers, through which materials, and particularly fluid borne materials can be transported to effect one or more preparative or analytical (in some embodiments, chromatographic or separation) manipulations on those materials. A microfluidic device is typically a chip comprising structural or functional features dimensioned on the order of mm-scale or less, and which is capable of manipulating a fluid at a flow rate on the order of μl/min or less. Typically, such channels or chambers include at least one cross-sectional dimension that is in a range of from about 0.1 μm to about 500 μm. The use of dimensions on this order allows the incorporation of a greater number of channels or chambers in a smaller area, and utilizes smaller volumes of reagents, samples, and other fluids for performing the preparative or analytical manipulation of the sample that is desired. As used herein, a “microfluidics system” also refers to a microfluidics device (for example, a chip) and all hardware, software, and components required to perform a preparative and/or analytical manipulation using the microfluidics device. A representative, non-limiting microfluidics system is depicted in FIG. 13.

Microfluidic systems are capable of broad application and can generally be used in the performance of chemical and biochemical synthesis, analysis, separation, and detection methods. The systems described herein can be employed in research, diagnosis, chromatographic techniques, environmental assessment, and the like. In particular, these systems, with their micron and submicron scales, volumetric fluid control systems, and integratability, can generally be designed to perform a variety of chemical and biochemical operations where these traits are desirable or even required. In addition, these systems can be used in performing a large number of specific assays that are routinely performed at a much larger scale and at a much greater cost.

A microfluidic device or chip can exist alone or may be a part of a microfluidic system which, for example and without limitation, can include: pumps for introducing fluids, e.g., samples, reagents, buffers and the like, into the system and/or through the system; detection equipment or systems; data storage systems; and control systems for (1) controlling fluid transport and/or direction within the device, and/or (2) monitoring and controlling environmental conditions to which fluids in the device are subjected, for example, temperature, current, and the like.

As used herein, the term “channel” or “microfluidic channel” can mean a cavity formed in a material by any suitable material removing technique, or can mean a cavity in combination with any suitable fluid-conducting structure mounted in the cavity such as a tube, capillary, or the like.

In referring to the use of a microfluidic device or chip for handling the containment or movement of fluid, the terms “in”, “on”, “into”, “onto”, “through”, and “across” the chip generally have equivalent meanings.

As used herein, the term “modified” means an alteration from an entity's normally occurring state. An entity can be modified by removing discrete chemical units or by adding discrete chemical units. The term “modified” encompasses detectable labels as well as those entities added as aids in purification.

As used herein, the term “monolithic” refers to a porous continuous bed. Monoliths can be prepared by in situ polymerization of an appropriate molecule inside of a support, for example, a column or a channel of a microfluidics chip. As such, a monolithic column can be a porous continuous bed that is supported by the column wall. A monolithic column, therefore, is to be contrasted with a packed column. Monolithic columns can be classified into two main types: organic monoliths prepared by arranging or polymerizing organic monomers to form a porous bed, and inorganic monoliths such as solgels comprising particles in inorganic gels or sintering silica beds. In one embodiment, a monolithic bed comprises a GFM.

As used herein, the term “mutation” carries its traditional connotation and means a change, inherited, naturally occurring or introduced, in a nucleic acid or polypeptide sequence, and is used in its sense as generally known to those of skill in the art.

As used herein, the terms “nucleic acid” and “nucleic acid molecule” mean any of deoxyribonucleic acid (DNA), ribonucleic acid (RNA), oligonucleotides, fragments generated by the polymerase chain reaction (PCR), and fragments generated by any of ligation, scission, endonuclease action, and exonuclease action. Nucleic acids can be composed of monomers that are naturally occurring nucleotides (such as deoxyribonucleotides and ribonucleotides), or analogs of naturally occurring nucleotides (e.g., α-enantiomeric forms of naturally-occurring nucleotides), or a combination of both. Modified nucleotides can have modifications in sugar moieties and/or in pyrimidine or purine base moieties. Sugar modifications include, for example, replacement of one or more hydroxyl groups with halogens, alkyl groups, amines, and azido groups, or sugars can be functionalized as ethers or esters. Moreover, the entire sugar moiety can be replaced with sterically and electronically similar structures, such as aza-sugars and carbocyclic sugar analogs. Examples of modifications in a base moiety include alkylated purines and pyrimidines, acylated purines or pyrimidines, or other well-known heterocyclic substitutes. Nucleic acid monomers can be linked by phosphodiester bonds or analogs of such linkages. Analogs of phosphodiester linkages include phosphorothioate, phosphorodithioate, phosphoroselenoate, phosphorodiselenoate, phosphoroanilothioate, phosphoranilidate, phosphoramidate, and the like. The term “nucleic acid” also includes so-called “peptide nucleic acids”, which comprise naturally-occurring or modified nucleic acid bases attached to a polyamide backbone. Nucleic acids can be either single stranded or double stranded.

As used herein, the term “polypeptide” means any polymer comprising any of the 20 protein amino acids, or amino acid analogs, regardless of its size or function. Although “protein” is often used in reference to relatively large polypeptides, and “peptide” is often used in reference to small polypeptides, usage of these terms in the art overlaps and varies. The term “polypeptide” as used herein refers to peptides, polypeptides and proteins, unless otherwise noted. As used herein, the terms “protein”, “polypeptide” and “peptide” are used interchangeably herein when referring to a gene product. The term “polypeptide” encompasses proteins of all functions, including enzymes.

### II. General Considerations

In one aspect, the presently disclosed subject matter comprises a matrix material (for example, a monolithic stationary phase) that can be employed in capillary electrophoresis and chromatography applications, in other similar microfluidic applications, and in generation microfluidic applications. The matrix material (for example, a stationary phase) comprises a gel comprising hydrogen-bonded guanine tetrads, (i.e. a G-quartet). Thus, disclosed herein for the first time is the use of G-quartet-comprising gels as a preparative and/or analytical medium, and in some embodiments as a monolithic phase in capillary chromatography. Moreover, the gels can be formed from or incorporate aptamers, so that the resultant gel can serve as both a stationary phase reagent and an anchoring medium or substrate, thus addressing a problem long-felt in the fields of capillary chromatography and capillary electrophoresis. In another embodiment, the gel can be employed as a medium for entrapping stationary phase packing particles, thereby eliminating the need for retaining frits and addressing the so-called “frit problem” associated with many CEC and CE stationary phases.

### III. Applications

The following sections describe several embodiments of the presently disclosed subject matter. Those of ordinary skill in the art will recognize that variations on the embodiments disclosed hereinbelow are possible. Such variations will be apparent to those of ordinary skill in the art upon consideration of the present disclosure.

III.A. Capillary Electrophoresis and Electrochromatography Matrix

In one aspect, the presently disclosed subject matter provides a capillary electrophoresis and electrochromatography matrix comprising a gel comprising a GFM, wherein the gel is in monolith form.

III.B. Capillary Electrophoresis and Electrochromatography Matrix Comprising Beads

In another aspect, the presently disclosed subject matter provides a capillary electrophoresis and electrochromatography matrix comprising beads embedded in a gel comprising a GFM. The gel can be in monolith form. In one embodiment, the beads are chromatography packing beads, for example, porous silica beads. In another embodiment, the beads are functionalized. In one embodiment, the beads are functionalized with a protein. In another embodiment, the beads are functionalized with an oligonucleotide. In one embodiment, the oligonucleotide is capable of hybridizing to a microbial nucleic acid.

III.C. Capillary Electrophoresis and Electrochromatography Column

In a further aspect, the presently disclosed subject matter provides a capillary electrophoresis and electrochromatography column comprising: (a) a matrix comprising a GFM; and (b) a support. The matrix can be a gel, and the gel can be in monolith form.

III.D. Method of Isolating a Target Analyte From a Mixture

In another aspect, the presently disclosed subject matter provides a method of isolating a target analyte from a mixture, the method comprising: (a) contacting a mixture known or suspected to comprise a target analyte with a matrix comprising a GFM; and (b) eluting the target analyte from the matrix. The matrix can be a gel, and the gel can be in monolith form. In one embodiment, the matrix comprises beads embedded therein. In another embodiment, the beads are chromatography packing beads. In another embodiment, the beads are functionalized. In another embodiment, the beads are functionalized with a protein. In still another embodiment, the beads are functionalized with an oligonucleotide.

In yet another aspect, the presently disclosed subject matter provides a method of detecting a target analyte in a mixture, the method comprising: (a) contacting a mixture known or suspected to comprise a target analyte with a matrix comprising a GFM; (b) washing the matrix under conditions sufficient to remove non-specifically bound material; and (c) detecting the target analyte bound to the matrix. The matrix can be a gel, and the gel can be in monolith form.

In one aspect, the presently disclosed subject matter comprises a gel-based format for microbial detection by nucleic acid hybridization analysis. Nucleic acid probes for hybridization detection can be incorporated into a gel matrix comprising degradation-resistant derivatives of guanine or guanine-rich nucleic acid sequences. A G quartet gel can comprise one or more oligonucleotides having or comprising a sequence of (G)ₓN_{y}(G)_{z}, where N_{y} is the sequence of the probe nucleic acid that is complementary to the sequences of the target nucleic acid to be detected. In this embodiment, (G)ₓ and (G)_{z} represent stretches of guanine nucleosides where x and z are any integer and x can, but does not necessarily, equal z. Representative values for x and z include, but are not limited to 0, 1, 2, 3, 4, 5, 6, 7, 8, 9, and 10. x and z can also be any integer between 10 and 50, including, for example, 15, 20, 25, 30, 35, 40, 45, and 50. Similarly, y is any integer including, but not limited to an integer between about 5 and 50, with the specific value of y being chosen based upon considerations of the conditions under which the hybridization of the N_{y} moiety to the target nucleic acid will occur. Hybridization conditions that will allow nucleic acid sequences of length between about 5 and 50 are known in the art (see e.g., Ausubel et al., 1992; Sambrook & Russell, 2001). The hybridization conditions and the value of y can also be chosen based upon the composition of the buffer in which the hybridization will take place: i.e. the mobile phase buffer. Stated another way, since the hybridization occurs within the stationary phase, the value of y can be chosen such that hybridization between the N_{y} moiety and the target nucleic acid will occur given the temperature of the stationary phase and the concentration of monovalent cation in the mobile phase buffer. In certain embodiments, y can, but does not necessarily, equal x and/or z.

The gel matrix can be stored in a container and dispensed as needed. A thin layer of the gel matrix can be applied to a substrate on which microbial detection takes place. Substrates or supports upon which microbial detection might be desired include, but are not limited to dosimeter-like detector badges, paper (for example, letters and packages), clothing, and skin. In one embodiment, the gel matrix is dispensed from a tube. In another embodiment, a gel matrix is dispensed from a pump spray device.

In an aspect of the presently disclosed subject matter, the gels, including the nucleic acid hybridization probes, are constructed from existing, degradation-resistant derivatives of ribonucleotides or deoxyribonucleotides. While a gel matrix can comprise a probe for the detection of one particular microbe, the gel matrix can also comprise more than one probe for multiplex detection of several organisms. In one embodiment, the hybridization probes are extended by the addition of G-rich sequences, such that the hybridization probes can be incorporated directly into the G-quartet network.

In order to perform the method of the presently disclosed subject matter in the detection of microbes, it is necessary to gain access to the nucleic acids present within the microbe including, but not limited to RNA and genomic DNA. In one embodiment, the gel matrix comprises a molecule (for example, an enzyme or an antibody) that lyses or causes the lysis of the microbial cells that come in contact with the gel matrix, thereby releasing the nucleic acids. In one embodiment, the molecule is an enzyme (for example, a lysozyme). In another embodiment, the molecule is an antibody.

In addition to a molecule that causes the microbe to lyse, the gel matrix can further comprise an enzyme that fragments the microbial nucleic acids. Enzymes that can be used for this purpose fall under the rubric nucleases, and include, but are not limited to endonucleases (such as restriction endonucleases) and exonucleases. In one embodiment, a restriction endonuclease recognizes a 4-base pair recognition sequence (for example, 5′-GATC-3′, which is recognized by several restriction endonucleases, including Mbo I and Dpn I).

As a result of the action(s) of the enzyme(s) included within the gel matrix, the nucleic acids present within a microbe that comes in contact with the gel matrix are made available to be detected by a hybridization probe of the gel matrix. This hybridization is thereafter detected and signaled using the methods of the presently disclosed subject matter. In one embodiment, the hybridization is signaled using a luminescent dye. In another embodiment, the hybridization is signaled electronically via the electron transport properties of G-quartet structures (for example, like that seen in “G-wires”; see e.g., Marsh & Henderson, 1994).

A variety of conditions can be employed for using the methods and compositions of the presently disclosed subject matter. For example, various mobile phase buffers can be used including, but not limited to Tris-based and phosphate-based buffers. Exemplary mobile phase buffers include either 25 mM Tris or 10 mM phosphate. As will be understood by one of ordinary skill in the art, the pH of the mobile phase buffer can be varied depending on considerations of, for example, the particular natures of the monolith and of the sample. Exemplary pH values for the mobile phase buffer include 4.0, 4.5, 5.0, 5.5, 6.0, 6.5, 7.0, 7.5, 8.0, 8.5, 9.0, 9.5, 10.0, 10.5, 11.0, 11.5, and 12.0, although both higher and lower pH values can be employed. In one embodiment, a mobile phase buffer comprises 25 mM Tris pH 7.2. In another embodiment, a mobile phase buffer comprises 25 mM Tris pH 7.3. In another embodiment, a mobile phase buffer comprises 10 mM phosphate pH 7.3. Mobile phase buffers can also contain potassium ion (for example, supplied as KCl). The concentration of potassium in the mobile phase buffer can be adjusted for optimal sample separation, and can range from 1 mM to 100 mM or more. In one embodiment, a mobile phase buffer comprises 2 mM KCl. In another embodiment, a mobile phase buffer comprises 100 mM KCl.

As will be understood by one of skill in the art, other CE or CEC parameters can also be varied without departing from the scope of the presently disclosed subject matter. For example, the separation of samples using CE or CEC can be performed using various potentials including, but not limited to voltages ranging from 5 kV to 20 kV. In one embodiment, an applied potential is 10 kV. In another embodiment, an applied potential is 15 kV. Additionally, the temperature at which the separation is performed can also be optimized. Representative separation temperatures can be chosen depending on parameters including, but not limited, to the composition of the monolith and the stability of the sample. Exemplary separation temperatures include, but are not limited to 4° C., 15° C., 20° C., 25° C., 30° C., 37° C., 42° C., 45° C., 50° C., 55° C., 60° C., 65° C., 70° C., 75° C., and even higher.

Another parameter that can be adjusted in the practice of the current presently disclosed subject matter regards the nature of the support for the monolith. A monolithic stationery phase can be produced in a column. As such, the inner diameters of the column can be adjusted to optimize the separation of a sample. In one embodiment, a column comprises a fused-silica capillary with an inner diameter of 25 μm. In another embodiment, a column comprises a fused-silica capillary with an inner diameter of 75 μm.

III.E. Microfluidics

Microfluidic systems have been developed for miniaturizing and automating the acquisition of chemical and biochemical information, in both preparative and analytical capacities. These systems have resulted in decreased cost and improved data quality. Microfluidic systems typically include one or more microfluidic chips for conducting and mixing small amounts of fluid, reagent, or other flowable composition or chemical for reaction and observation. Microfluidic chips can be fabricated using photolithography, wet chemical etching, laser micromachining, and other techniques used for the fabrication of microelectromechanical systems. Generally, microfluidic systems can also include one or more computers, detection equipment, and pumps for controlling the fluid flow into and out of the chip for mixing two or more reagents or other fluids together at specific concentrations and observing any resulting reaction.

Microfluidic systems can also employ electroosmotic control to regulate the flow of fluids. In this embodiment, the flow of materials through the microfluidic system is controlled by electrodes in fluidly connected wells having a coupled current and/or voltage controller. This current and/or voltage controller can function similarly to those employed in capillary electrophoresis by producing a potential difference between the inlet and outlet ports of the microfluidic system. See e.g., Seller et al., 1994.

Typically, microfluidic chips include a central body structure in which various microfluidic elements are formed for conducting and mixing fluids. The body structure of the microfluidic chip can include an interior portion that defines microscale channels and/or chambers. Typically, one or more different fluids are advanced to a mixing junction or region at a controlled rate from their respective sources for mixing at desired concentrations. The mixed fluids can then be advanced to at least one main channel, a detection or analysis channel, whereupon the mixed fluids can be subjected to a particular analysis by detection equipment and analysis equipment, such as a computer. Typically, the detection equipment includes a light source for illuminating the mixed fluids contained in the detection channel/region for detection by a light detector. The light can be reflected from and/or pass through the contents of the detection channel/region for detection by the light detector. With regard to some of the embodiments and applications disclosed herein, the microfluidics chip or apparatus can comprise one or more G-quartet forming oligonucleotides.

A schematic diagram of an exemplary embodiment of a microfluidic system, generally designated 100, for mixing fluids is illustrated in FIG. 13. System 100 can include a microfluidic chip 102 having fluid connection to a first and second microfluidic pump 104 and 106 for advancing fluids through chip 102 for mix and analysis. In this embodiment, pumps 104 and 106 are syringe pumps, which can be driven by an appropriate motor. Alternatively, pumps 104 and 106 can comprise peristaltic pumps, pressure-driven pumps, conducting polymer pumps, electroosmotic pumps, bubble pumps, piezoelectric driven pumps, or another type of pump suitable for pumping fluids through microfluidic chips. Pumps 104 and 106 can produce volumetric flow rates that are individually controllable by a computer 108.

Alternatively or in addition, pumps 104 and/or 106 can function to inject a sample into microfluidics device 100 and the flow of the sample through the device can be controlled by voltage regulator 116, the leads from which are connected to microfluidics chip 102 in order to establish a potential difference across microfluidic chip 102.

According to one embodiment, computer 108 can be a general-purpose computer including a memory for storing program instructions for operating pumps 104 and 106. Alternatively, computer 108 can include a disk drive, compact disc drive, or other suitable component for reading instructions contained on a computer-readable medium for operating pumps 104 and 106. Further, computer 108 can include instructions for receiving, analyzing, and displaying information received from detection equipment, generally designated 110, described in further detail below. Computer 108 can also include a display, mouse, keyboard, printer, or other suitable component known to those of skill in the art for receiving and displaying information to an operator.

After injection into chip 102, a fluid can be advanced to a detection channel/region, or analysis channel/region, on chip 102 and subjected to analysis by detection equipment 110. Typically, the fluid travels a length of channel before reaching the detection channel/region to enable interaction of the components of the fluids with the matrix. The detection channel/region can include a point at which measurement, e.g., absorbance of ultraviolet (UV) light measured in absorbance units (AU), of the fluid is acquired by a suitable data acquisition technique. Detection equipment 110 can be operably connected to computer 108 for receiving and storing the measurement acquired from the detection channel/region. Computer 108 can also perform analysis of measurement from detection equipment 110 and present an analysis of the measurement to an operator in a human-readable form. After an experiment has been run and measurement has been acquired, the fluid can flow from the detection channel/region to any suitable collection site for recovery or disposal.

A microfluidic chip can comprise a central body structure in which the various microfluidic elements are disposed. The body structure can include an exterior portion or surface, as well as an interior portion that defines the various microscale channels, fluid mixing regions, and/or chambers of the overall microscale device. For example, the body structures of microfluidic chips typically employ a solid or semi-solid substrate that is typically planar in structure, i.e., substantially flat or having at least one flat surface. Suitable substrates can be fabricated from any one of a variety of materials, or combinations of materials. Typically, the planar substrates are manufactured using solid substrates common in the fields of microfabrication, e.g., silica-based substrates, such as glass, quartz, silicon, or polysilicon, as well as other known substrates, such as sapphire, zinc oxide alumina, Group III-V compounds, gallium arsenide, and combinations thereof. In the case of these substrates, common microfabrication techniques such as photolithographic techniques, wet chemical etching, micromachining, i.e., drilling, milling and the like, can be readily applied in the fabrication of microfluidic devices and substrates. Alternatively, polymeric substrates materials can be used to fabricate the devices described herein, including, e.g., polydimethylsiloxanes (PDMS), polymethylmethacrylate (PMMA), polyurethane, polyvinylchloride (PVC), polystyrene polysulfone, polycarbonate, polymethylpentene, polypropylene, polyethylene, polyvinylidine fluoride, acrylonitrile-butadiene-styrene copolymer (ABS), cyclic olefin copolymers, and the like. In the case of such polymeric materials, laser ablation, injection molding, or embossing methods can be used to form the substrates having the channels and element geometries as described herein. For injection molding and embossing, original molds can be fabricated using any of the above described materials and methods.

In an embodiment of FIG. 13, detection equipment 110 can monitor the progress of analytes present in the mobile phase at the detection channel via UV absorbance. For example, as molecules of biological interest (for example, peptides, polypeptides, and nucleic acids) proceed to the detection channel, UV absorbance can decrease due to binding of the molecules of biological interest to the G-gel or separation of various components of a complex mixture of these molecules from each other under the influence of the G-gel. Similarly, absorption of UV light by a molecule can be measured using a UV spectrophotometer to measure the passage of molecules through the detection channel.

For fluorescence detection, a fluorescence microscope can be employed. Alternatively, any type of light path known to those of skill in the art can be employed. The excitation light sources can be any suitable light source LS, such as green Helium Neon (HeNe) lasers, red diode lasers, and diode-pumped solid state (DPSS) lasers (532 nanometers). Incandescent lamps and mercury and xenon arclamps in combination with chromatic filters or diffraction gratings with slits can also be used as excitation sources. Excitation sources can include combinations of these, for example, multiple lasers or lasers combined with arclamps and chromatic filters and diffraction gratings with slits. Detection equipment 110 can include a light detector LD for detecting the light reflecting from and/or passing through the detection channel/region where a reaction occurs. Avalanche photodiodes (APDs) and photo-multiplier tubes (PMTs) can also be used. Light source LS and light detector LD can be coupled to a microscope having mirrors 112 and lenses 114. Other optical configurations can be used, such as fiber optic delivery of light from the excitation source to the chip and from the sample in the chip to the photodetector.

Other methods for detection can include phosphorescence, variants of fluorescence (e.g., polarization fluorescence, time-resolved fluorescence, fluorescence emission spectroscopy, fluorescence resonant energy transfer), and other non-optical techniques using sensors placed into the fluid flow, such as pH or other ion-selective electrodes, conductance meters, and capture/reporter molecules.

Continuing with FIG. 13, computer 108 can include hardware and software computer program products comprising computer-executable instructions embodied in computer-readable media for controlling pumps 104 and 106. Computer 108 can also control and analyze the measurements received from detection equipment 110. Computer 108 can provide a user interface for presenting measurements and analysis to an operator and receiving instructions from an operator. Certain concepts discussed herein relate to a computer program product, for causing computer 108 to control pumps 104 and 106, light source LS, and light detector LD. Different methods described herein for controlling the components of system 100 can be implemented by various computer program products. For example, a programmable card can be used to control pumps 104 and 106, such as a PCI-7344 Motion Control Card, available from National Instruments Corporation, Austin, Tex. Methods for controlling pumps 104 and 106 to achieve a desired fluid mix and receive analysis data from detection equipment 110 can be programmed using C++, LABVIEW™ (available from National Instruments Corporation), or any other suitable software. Such a computer program product comprises computer-executable instructions and/or associated data for causing a programmable processor to perform the methods described herein. The computer-executable instructions can be carried on or embodied in computer-readable medium.

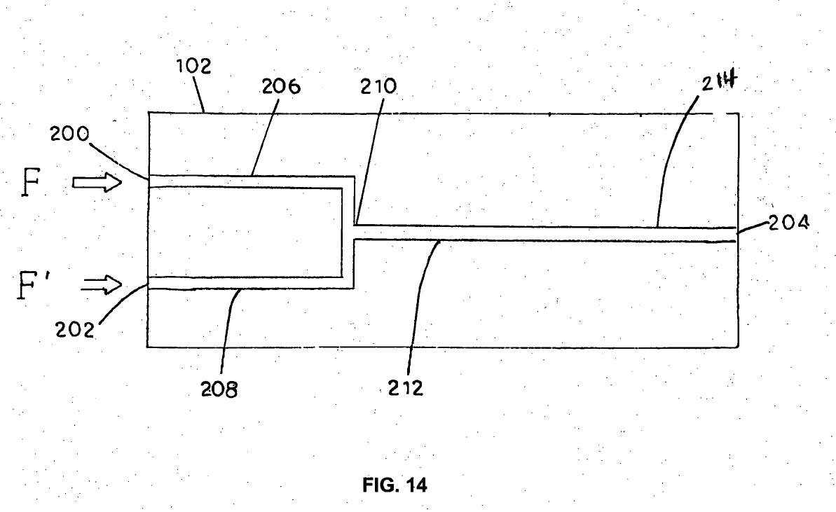

Referring to FIG. 14, a schematic diagram of the channel and mixing region layout of microfluidic chip 102 is illustrated. Microfluidic chip 102 can include two inputs 200 and 202 connected to pumps 104 and 106 (shown in FIG. 13), respectively, for advancing fluids F and F′ through the channels of chip 102. Fluids F and F′ from inputs 200 and 202, respectively, can be advanced by pumps 104 and 106, respectively, through premixing channels 206 and 208, respectively, and combined downstream at a fluid mixing junction 210. Premixing channels 206 and 208 can also function to equilibrate the temperature of fluids F and F′ in the channels to a surrounding temperature. In an alternative embodiment, microfluidic chip 102 can include more than two channels for combining more than two separate, and different if desired, fluids at the mixing junction or at multiple mixing junctions. In yet another alternative embodiment, microfluidic chip 102 can include one channel leading directly from input 200 to output 204.

In an embodiment of FIG. 14, microfluidic chip 102 can operate as a passive mixer such that all mixing occurs by diffusion. Therefore, microfluidic chip 200 can include a mixing channel 212 downstream from mixing junction 210 to allow fluids F and F′ to adequately mix prior to detection downstream. Alternatively, mixing can be enhanced by the inclusion of structures in the microfluidic channels that generate chaotic advection, or mixing can be actively performed by the inclusion of moving, mechanical stirrers such as magnetic beads driven by an oscillating magnetic field. Mixing junction 210 can be configured in any suitable configuration, such as what is known as a T-junction as shown in FIG. 14. The fluid streams from channels 206 and 208 therefore can combine laterally towards each other.

Continuing with FIG. 14, microfluidic chip 200 can also include a channel 212 in communication with mixing junction 210 and positioned downstream therefrom. Channel 212 can operate as an aging loop for allowing a reaction (for example, an interaction between an analyte and a G-gel) to proceed for a period of time before reaching a detection region 214. The length of an aging loop and the linear velocity of the fluid determine the time period of the reaction. Longer loops and slower linear velocities produce longer reactions. The lengths of aging loops can be tailored to a specific reaction or set of reactions, such that the reactions have time to complete during the length of the channel. Conversely, long aging loops can be used and shorter reaction times can be measured by detecting closer to mixing junction 210.

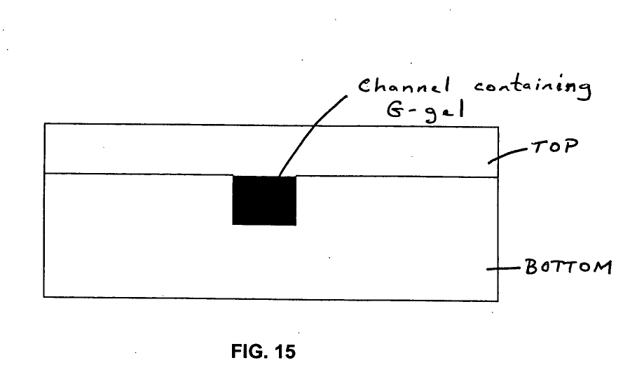

Referring to FIG. 15, a schematic diagram of a cross-sectional view of the channel layout of microfluidic chip 102 is illustrated. FIG. 15 depicts the upper (TOP) and lower (BOTTOM) planar substrates that make up the chip. The channel is depicted as a depression in the lower planar substrate. In FIG. 15, this channel is filled with a G-gel, depicted as a shaded box.

Channels, fluid mixing regions, and chambers of microfluidic chips can be fabricated into one surface of a planar substrate, as grooves, wells, depressions, or other suitable configurations in that surface. A second planar substrate, typically prepared from the same or similar material, can be overlaid and bonded to the first, thereby defining and sealing the channels, mixing regions, and/or chambers of the device. Together, the upper surface of the first substrate and the lower mated surface of the upper substrate define the interior portion of the device: i.e., defining the channels, fluid mixing junctions, and chambers of the device. Alternatively, the surfaces of two substrates can be etched and mated together for defining the interior portion of the device.

Microfluidic chips typically include at least one detection channel, also termed an analysis channel, through which fluids are transported and subjected to a particular analysis. In certain embodiments, fluid samples can be advanced from their respective sources to the detection channel by placing the fluids in channels that intersect at a fluid mixing junction. The fluids can be advanced through the channels at predetermined fluid velocities to achieve desired fluid mixes at the mixing region.

In one embodiment, a microfluidics apparatus (for example, a microfluidics chip) of the presently disclosed subject matter comprises one or more GFMs. As described in more detail hereinabove, the GFMs can be employed for numerous preparative and/or analytical techniques, and each of these techniques can be employed within a microfluidics apparatus. Exemplary, non-limiting applications of G-gels (i.e. gels containing G-quartet-forming nucleosides and/or oligonucleotides) in the context of microfluidics include (a) the transportation and delivery of analytes and reagents, taking advantage of the reversible nature of G-gels that can be controlled by temperature, pH, and/or the local concentration of specific ions such as K⁺; (b) the capture and recovery of target molecules, the removal of undesirable sample components, and the isolation and pre-concentration of analytes; (c) hybridization detection, mutation analysis, affinity capture, and directed proteomics using G-gels containing oligonucleotides such as hybridization probes, aptamers, and/or genetic DNA; (d) the use of G-gels as stationary or mobile phases for electrophoresis or electrochromatography; and (e) the use of G-gels to support bioactive microreactors such as enzyme-coated microspheres or living cells.

In one embodiment, a G-gel of the presently disclosed subject matter is present within the channels of the microfluidics chip. G-gels can be introduced into the channels of the microfluidics chip by employing any relevant technique including, but not limited to introducing a G-quartet forming material in mobile phase buffer into the device at a temperature above the gelation temperature of the G-quartet forming material, and then lowering the temperature of the device to below the gelation temperature, whereby the G-gel forms.

Stationary gel phases can be implemented in microfluidic devices in the presence or absence of an applied electric field. This can be accomplished, for example, by employing neutral guanosine nucleosides and coating the channels of the device with the gel to eliminate electroosmotic flow (EOF). By analogy, mobile gels can be either neutral nucleosides or negatively charged nucleosides in the presence of an EOF in an electric field.

In certain embodiments, various functionalities can be incorporated into the G-gel used in a microfluidics application. These functionalities include, but are not limited to oligonucleotides, antibodies, enzymes, and microspheres, the latter of which can also serve as supports for functional entities. Additionally, streptavidinated molecules can be linked to the backbone of a gel that includes a small percentage of biotinylated nucleosides. Alternatively or in addition, biotinylated molecules can be attached to streptavidin-coated microspheres that are suspended in the gel.

### IV. Advantages

In one aspect, the presently disclosed subject matter provides a novel stationary phase suitable for use as a capillary electrophoresis and/or a capillary electrochromatography matrix. In another aspect, the matrix comprises a gel comprising a GFM. The gel can be in monolith form. The matrix can be used for separation of, for example, chiral compounds, peptides and proteins.

The G-quartet stationary phase offers several advantages that distinguish it from other matrix reagents for preparative and/or analytic methods, including but not limited to chromatographic separations:

(a) Solvent compatibility. The matrices of the presently disclosed subject matter are compatible with aqueous buffers as well as with mixed solvent systems containing as much as 70% organic solvent. The inclusion of organic solvents is often beneficial to separations and is also desirable for mass spectrometric detection. Many known matrices, while useful in separations, are not compatible with organic solvents.

(b) Chiral selectivity. The matrices of the presently disclosed subject matter exhibit chiral selectivity and can therefore be employed in the separation of enantiomeric compounds in a manner similar to cyclodextrins, but with a broader range or applications and without the limited aqueous solubility and size-exclusion disadvantages of cyclodextrins.

(c) Less denaturing. In one aspect, the matrices of the presently disclosed subject matter are formed from nucleosides and/or oligonucleotides and, as such, they have an ability to interact with amino acid based structures such as peptides and proteins. These interactions are more likely to preserve the native protein conformation than the relatively harsh or denaturing conditions often encountered in reverse phase-HPLC (RP-HPLC), two-dimensional polyacrylamide gel electrophoresis (2-D PAGE), and capillary gel electrophoresis.

(d) Easily synthesized. G-quartet phases are constructed from simple, inexpensive molecules such as guanosine, or from oligonucleotides that are reproducibly, accurately, and easily synthesized in a short time by automated processes.

(e) Complementarity to existing techniques for protein separations. The underlying mechanisms of G-quartet-based separations (steric, hydrophobic, electrostatic and hydrogen-bonding interactions) are different from those of other techniques and can therefore serve to separate proteins that would not be easily separated by isoelectric point, size, or charge/mass ratio. The use of non-denaturing conditions can serve to separate different conformational variants of a protein.

(f) Compatible with MS detection. An important consideration in many applications of peptide and protein analysis, particularly in proteomics, is compatibility with mass spectrometric detection. Capillary LC or CEC with G-quartet stationary phases is well suited to on-line electrospray mass spectrometry (ESI-MS) because it can be performed using low conductivity buffers and mixed solvent systems without detergents, denaturants, complexing agents, or other additives in the mobile phase. It is, of course, also possible to collect capillary effluent for analysis by MALDI-MS.

(g) Melting of the G-quartet gels is reversible.

(h) G-quartet gel materials provide a convenient matrix for on-site, self-contained nucleic acid hybridization detection of microbial agents and other microorganisms.

(i) In microfluidic devices, the reversibility of the G-gel will allow it to be melted to release analytes that can be diverted away from the gel-forming material based on, for example, differences in charged state, in order to detect the analyte without interference from background signal from the gel.

### EXAMPLES

The following Examples have been included to illustrate modes of the presently disclosed subject matter. In light of the present disclosure and the general level of skill in the art, those of skill will appreciate that the following Examples are intended to be exemplary only and that numerous changes, modifications, and alterations can be employed without departing from the scope of the presently disclosed subject matter.

### Example 1

### Chiral Separation of Propranolol Enantiomers

The presently disclosed matrix materials were used to separate two enantiomers of the drug propranolol, L-propranolol and D-propranolol, from each other in a racemate of DL-propranolol under various conditions. The following conditions were used for separations as described in Examples 2-10.

Base fused silica capillaries (50 μm inner diameter) were purchased from Polymicro Technologies (Phoenix, Ariz., United States of America). All reagents were purchased from Sigma-Aldrich Corp. (St. Louis, Mo., United States of America). Gel solutions were prepared in 25 mM potassium or sodium phosphate buffer, pH 7.0, unless otherwise specified. The gel solutions were allowed to sit at room temperature overnight before use. Propranolol stock solutions contained 1.0-1.5 mg/ml DL-propranolol in 24.5 mM citrate/51.4 mM potassium phosphate buffer at pH 5.0. Propranolol samples were prepared by diluting the propranolol stock solution with the gel solution that was to be used as the mobile phase.

Capillary electrophoresis experiments were performed on a Beckman Coulter P/ACE™ 5000 CE (Beckman Coulter, Inc., Fullerton, Calif., United States of America). The instrument was set in forward polarity mode, with the anode at the outlet. The total length of the capillaries was 37 cm, and the length to the detection window was 30 cm. Capillaries were contained in a temperature-controlled cartridge, with experimental temperatures ranging from 15° C. to 25° C. Absorbance was detected at 214 nm.

At the beginning of each day, the capillary was conditioned by rinsing at high pressure (20 psi) with 0.1 M NaOH for 10 minutes, followed by deionized water for 5 minutes, and the mobile phase for 10 minutes. Between each run, the capillary was high-pressure rinsed with 0.1 M NaOH for 3 minutes, deionized water for 2 minutes, and the mobile phase for 3 minutes. Samples were introduced into the capillary using hydrodynamic injections at 0.5 psi for 1-5 seconds. Field strengths ranged from 81-405 V/cm.

### Example 2

### Chiral Separation of Propranolol Enantiomers on a Bare Capillary

Capillary zone electrophoresis separation of 0.1 mg/ml DL-propranolol was attempted using a bare capillary according to the parameters outlined in Example 1. Briefly, the mobile phase was 25 mM potassium phosphate, pH 7.0 containing 0.02 M KCl. The sample plug was hydrodynamically injected over 1 second, the field strength was 135 V/cm, and the run temperature was 15° C.

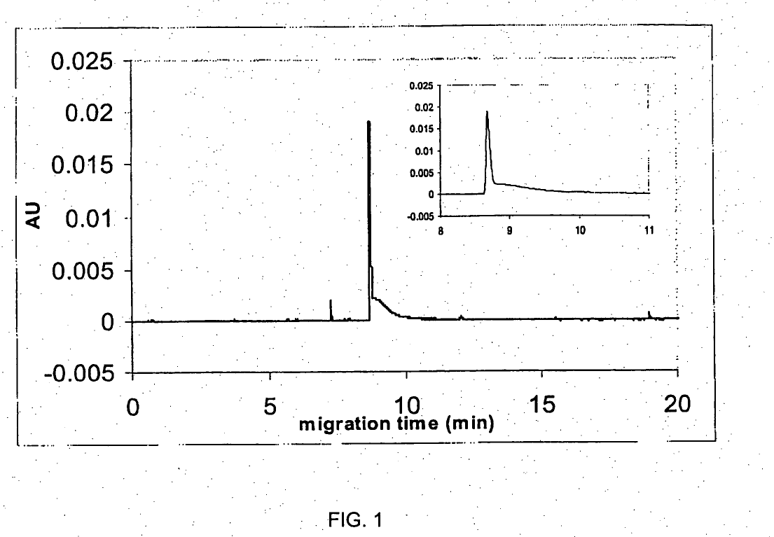

FIG. 1 depicts an electropherogram showing the results of the separation under these conditions. FIG. 1 shows that there is no resolution by the bare capillary of the enantiomers, which co-elute at about 9 minutes.

### Example 3

### Chiral Separation of Propranolol Enantiomers in the Presence of 5′-GMP

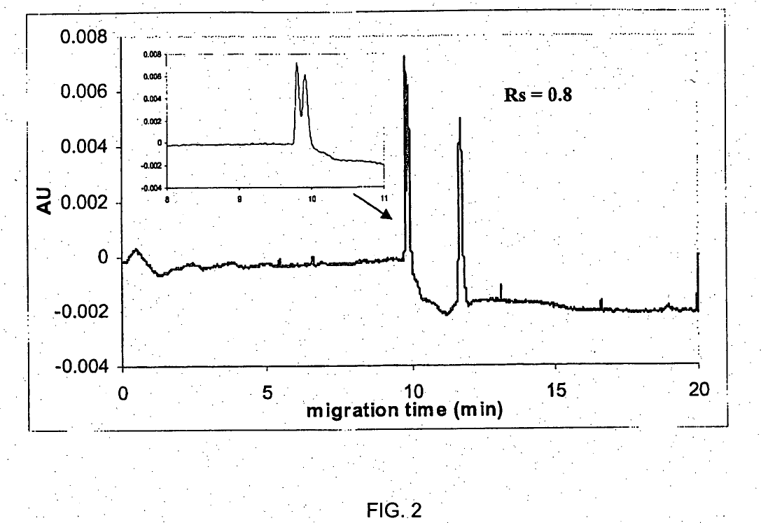

FIG. 2 depicts an electropherogram under conditions identical to the run described in Example 2, except that 0.01 M 5′-GMP was added to the mobile phase. As can be seen, partial resolution of the enantiomers was accomplished with the addition of the 5′-GMP. Since G-gels absorb below 300 nm, the presence of the 5′-GMP contributed a background to the signal across the electropherogram. The single peak eluting at about 12 minutes was a blank signal associated with changes in the gel phase upon injection of buffer, whether or not it contained propranolol.

### Example 4

### Effect of 5′-GMP Concentration on Chiral Separation

The effect of 5′-GMP concentration was tested using the run conditions described in Example 3, except that the run was performed at 20° C. instead of 15° C.

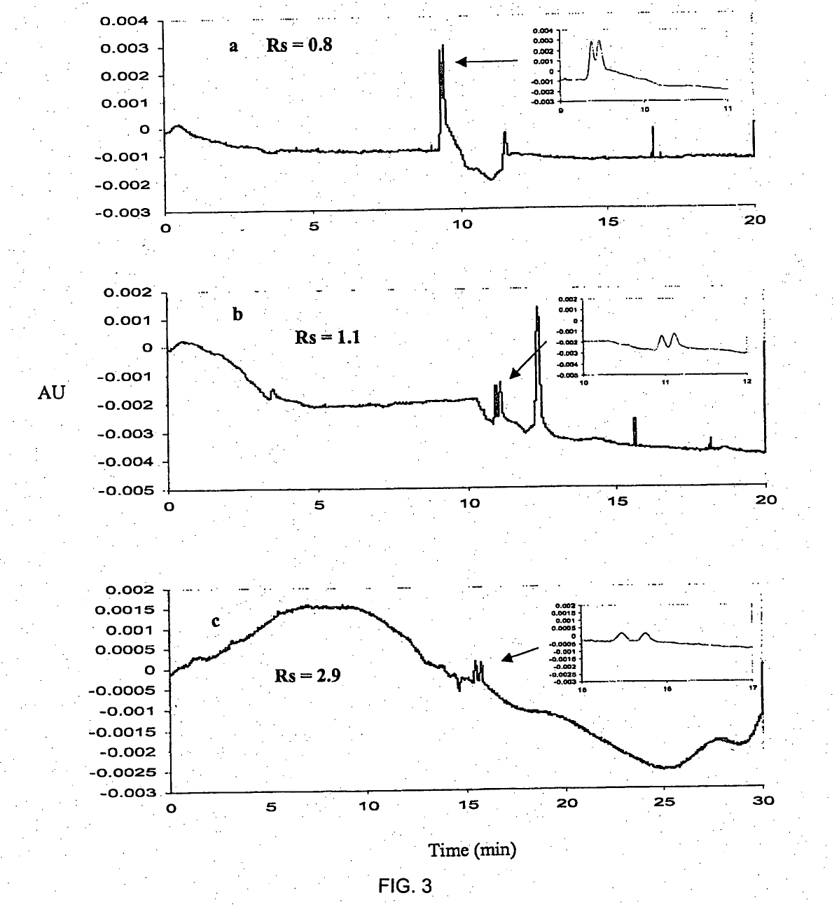

FIG. 3 depicts three electropherograms of 0.05 mg/ml DL-propranolol in the presence of different concentrations of 5′-GMP. In the top panel, the 5′-GMP concentration was 0.01 M; in the middle panel, the 5′-GMP concentration was 0.02 M; and in the bottom panel, the 5′-GMP concentration was 0.05 M. FIG. 3 demonstrates that under increasing 5′-GMP concentration, the resolution of the enantiomers improved, but the stability of the baseline decreased.

### Example 5

### Effect of K⁺ Concentration on Chiral Separation

The effect of K⁺ concentration in the mobile phase one the organization of a 5′-GMP gel was determined. Run conditions were 0.02 M 5′-GMP in 25 mM potassium or sodium phosphate buffer at pH 7.0. DL-propranolol (0.5 mg/ml) was introduced using a 1 second hydrodynamic injection. The field strength was 189 V/cm.

Table 1 shows the resolution as a function of additional K⁺ (added as KCl) in the mobile phase for both potassium phosphate and sodium phosphate buffers. The K⁺ concentrations in Table 1 are in addition to the K⁺ or Na⁺ already contributed to the mobile phase from the buffer.

TABLE 1
Influence of Added K⁺ on Resolution

| Conc. | | | | |
|---|---|---|---|---|
| KCl | Rₛ | Mean | Rₛ | Mean |
| (M) | (potassium PO₄) | Rₛ* | (sodium PO₄) | Rₛ* |
| 0.00 | 1.087, 1.005 | 1.05 | 0.978, 0.996 | 0.99 |
| 0.10 | 1.148 | (1.15) | (not done) | — |
| 0.20 | 1.281, 1.051 | 1.28 | 1.066, 1.023 | 1.04 |
| 0.40 | 0.968, 1.051 | 1.01 | 1.088, 1.070 | 1.08 |

*Identical runs were performed in duplicate, with the exception of the run at [KCl] = 0.01 M. The Mean Rₛ is the average of the two readings.

As can be seen from Table 1, in the sodium phosphate buffer, the resolution increased with increasing K⁺, most likely due to the promotion of gelation attributed to potassium ions. See e.g. Walmsley et al., 1999; Mariani et al., 1998. In comparing the sodium buffer system to the potassium buffer system, Table 1 reveals that the resolution of the two peaks was greater in the potassium buffer system from 0 to about 0.2 M K⁺. At 0.4 M K⁺, the resolution of the enantiomers decreased in the potassium buffer system. The resolution was also lower than that observed in the sodium buffer system at the same concentration of added K⁺. It might be possible that there is a point at which increasing the K⁺ concentration begins to inhibit the interaction of the analytes with the gel due to the high ionic strength of the buffer.

### Example 6

### Effect of Temperature on Chiral Separation

The effect of temperature on the ability of the 5′-GMP-containing gels were tested by running the separations under temperature conditions ranging from 15° C. to 25° C. For each separation run, the mobile phase contained 25 mM potassium phosphate buffer at pH 7.0 with 0.02 M KCL. DL-propranolol (0.5 mg/ml) was introduced using a 1 second hydrodynamic injection. The field strength was 189 V/cm.

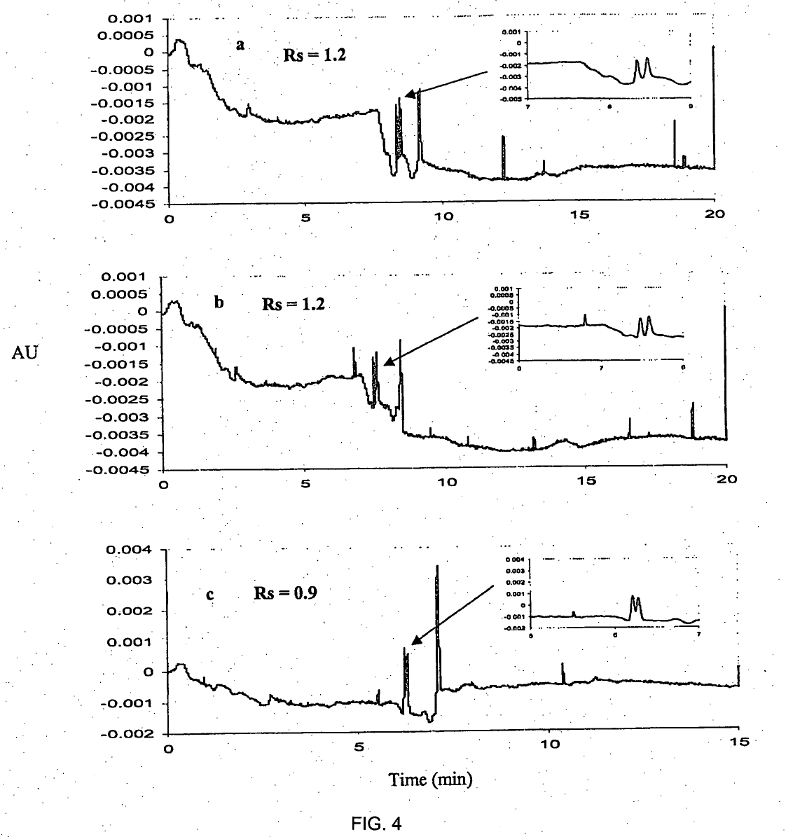

FIG. 4 presents three electropherograms depicting the separation of 0.05 mg/ml DL-propranolol at different run temperatures. In the top panel, the run temperature was 15° C.; in the middle panel, the run temperature was 20° C.; and in the bottom panel, the run temperature was 25° C. FIG. 4 demonstrates that under increasing run temperature, the resolution of the enantiomers decreased, most likely due to a decrease in the chiral structure of the gel as it began to lose its organization at higher temperatures.

### Example 7

### Effect of Electric Field Strength on Chiral Separation

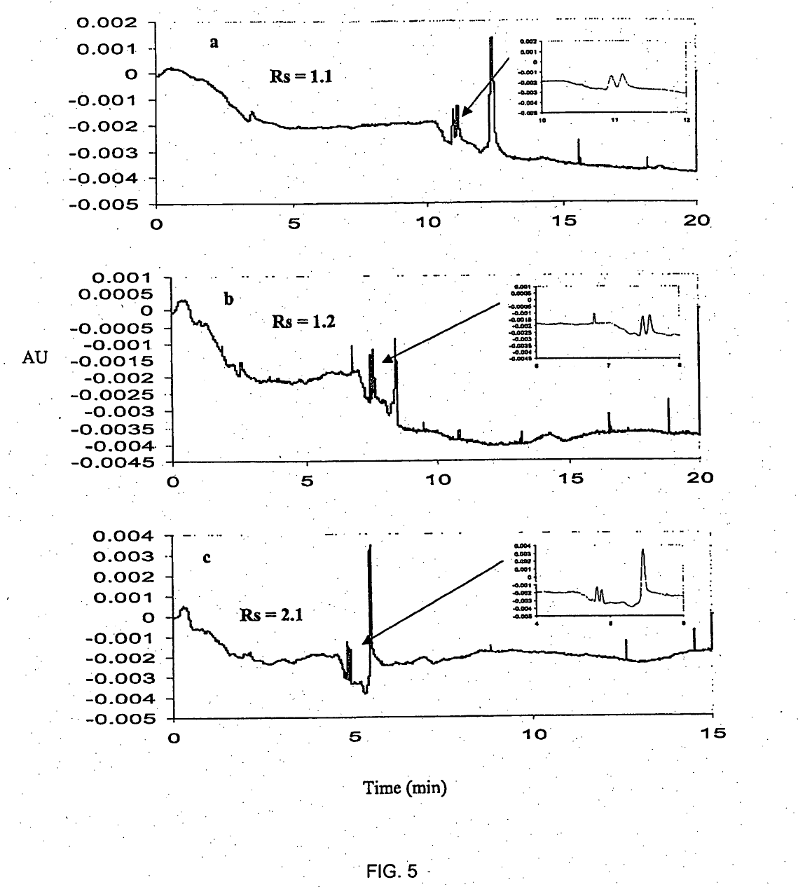

FIG. 5 depicts three electropherograms of the separation of 0.05 mg/ml DL-propranolol under conditions of different electric field strength. In the top panel, the run was at 135 V/cm; in the middle panel, the run was at 189 V/cm; and in the bottom panel, the run was at 270 V/cm. Other run conditions were a mobile phase of 0.02 M 5′-GMP in 25 mM potassium phosphate, pH 7.0 with 0.02 M KCl; 1 second hydrodynamic injection; at 20° C. FIG. 5 demonstrates that under increasing electric field strength, the resolution of the enantiomers increased, most likely due to band broadening at lower field strengths as the sample plug spent increasing amounts of time in the capillary.

### Example 8

### Effect of Organic Additives on Chiral Separation

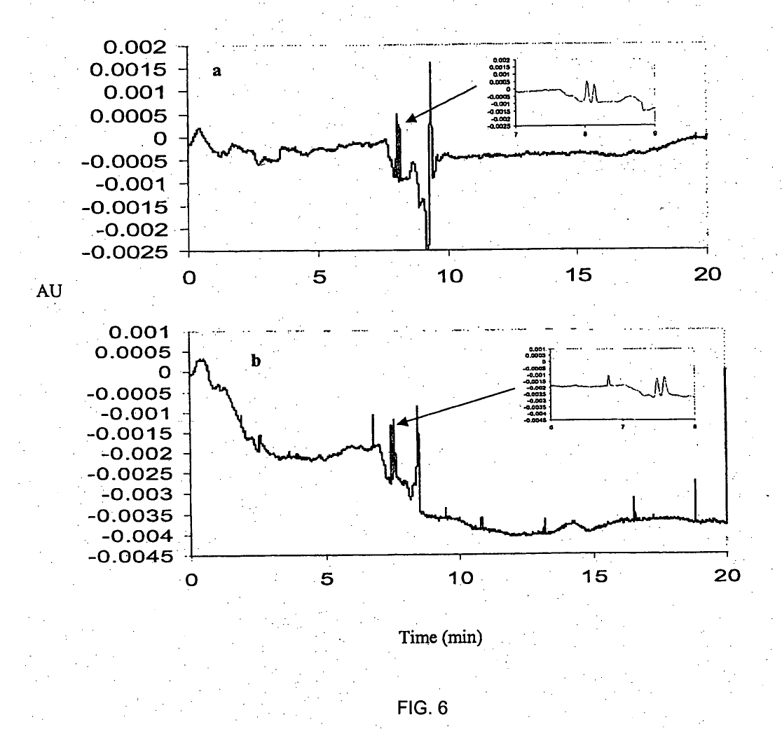

The use of organic additives often enhances the resolution of enantiomers in capillary electrophoresis. See Armstrong et al., 1994; Ward et al., 1995; Liu et al., 1999. FIG. 6 depicts two electropherograms of the separation of 0.05 mg/ml DL-propranolol in the presence or absence of an organic additive: 2-propanol. In the bottom panel, the run conditions were a mobile phase of 0.02 M 5′-GMP in 25 mM potassium phosphate, pH 7.0 with 0.02 M KCl; 1 second hydrodynamic injection; 189 V/cm; at 20° C. The top panel depicts identical run conditions except that 5% v/v 2-propanol was added to the mobile phase. FIG. 6 demonstrates that the addition of 2-propanol improved the quality of the baseline in the electropherogram. The effects on resolution are presented in Table 2.

TABLE 2
The Effect of 2-Propanol on Resolution

| | Rₛ in potassium PO₄ | Rₛ in sodium PO₄ |
|---|---|---|
| % (v/v) 2-Propanol | (mean) | (mean) |
| 0 | 1.281, 1.276 | 1.066, 1.023 |
| | (1.28) | (1.04) |
| 5 | 1.333, 1.292 | 1.230, 1.186 |
| | (1.31) | (1.21) |

The data presented in Table 2 demonstrates that 2-propanol improved the resolution of the enantiomers in both potassium and sodium phosphate buffers.

### Example 9

### Effect of Organic Additives on Field Strength and Current

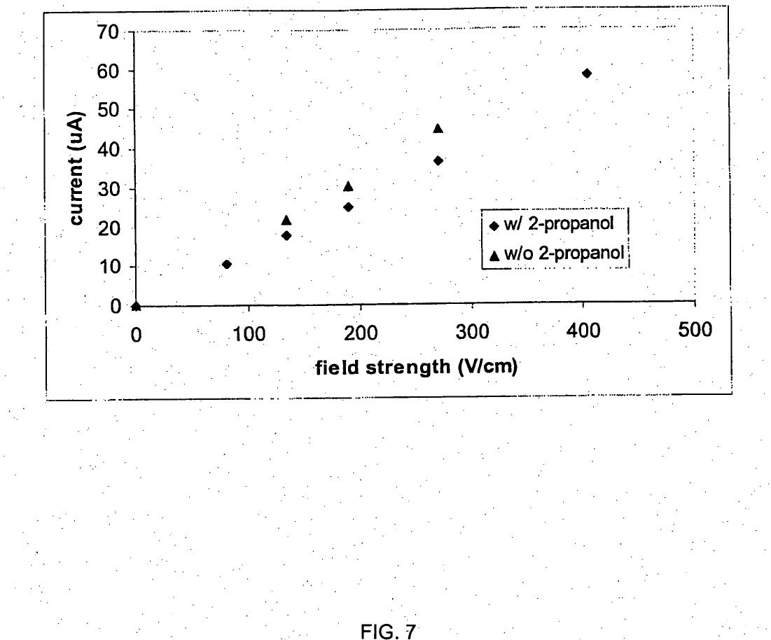

FIG. 7 depicts an Ohm's Law plot of field strength vs. current in the presence or absence of 2-propanol. Run conditions were 0.02 M 5′-GMP in 25 mM potassium phosphate, pH 7.0 with 0.02 M KCl; at 20° C. In each case, the field strength used for the enantiomeric separations were within the linear range of the plot and the generated currents were sufficiently low to conclude that Joule heating was unlikely to be a significant consideration for the 5′-GMP gel mobile phases under these conditions.

### Example 10

### Reproducibility of Multiple Runs on the Same Column

The reproducibility of resolution and migration times was tested by running multiple, consecutive separations on the same column. Run conditions were 0.02 M 5′-GMP in 25 mM potassium phosphate, pH 7.0 with 0.02 M KCl; 1 second hydrodynamic injection; 270 V/cm; at 20° C. Between runs, the column was regenerated using the wash procedure described in Example 1.

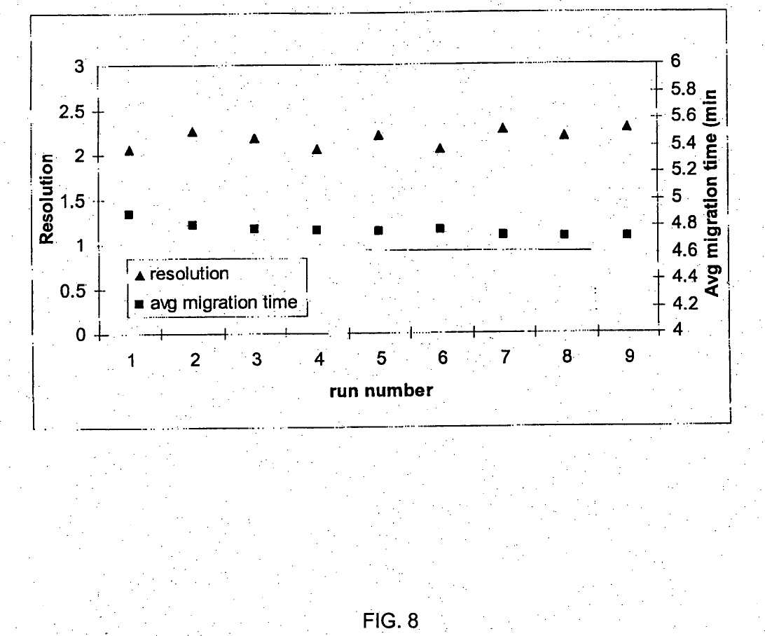

FIG. 8 shows the results of the resolution (Rₛ) and migration times (taken at the midpoint between the two peaks) for nine consecutive separations of 0.05 mg/ml DL-propranolol on a single column. The average resolution was 2.2±0.1 (±4.5%) and the average migration time was 4.77±0.06 minutes (±1.3%). The fluctuations in resolution appeared to be random, while there was a slight downward trend in migration time, particularly in the first 2-3 runs. The decrease in retention time might have been be due to modifications of the fresh capillary over the course of the runs, or effects of minor changes in ambient temperature on the gel mobile phase.

### Example 11

### Reversible Incorporation of Hybridization Probes into G-Gels

G-gels are used to capture and release molecular targets and/or analytes by employing a G-gel that incorporates an aptameric oligonucleotide that binds to the target molecule.

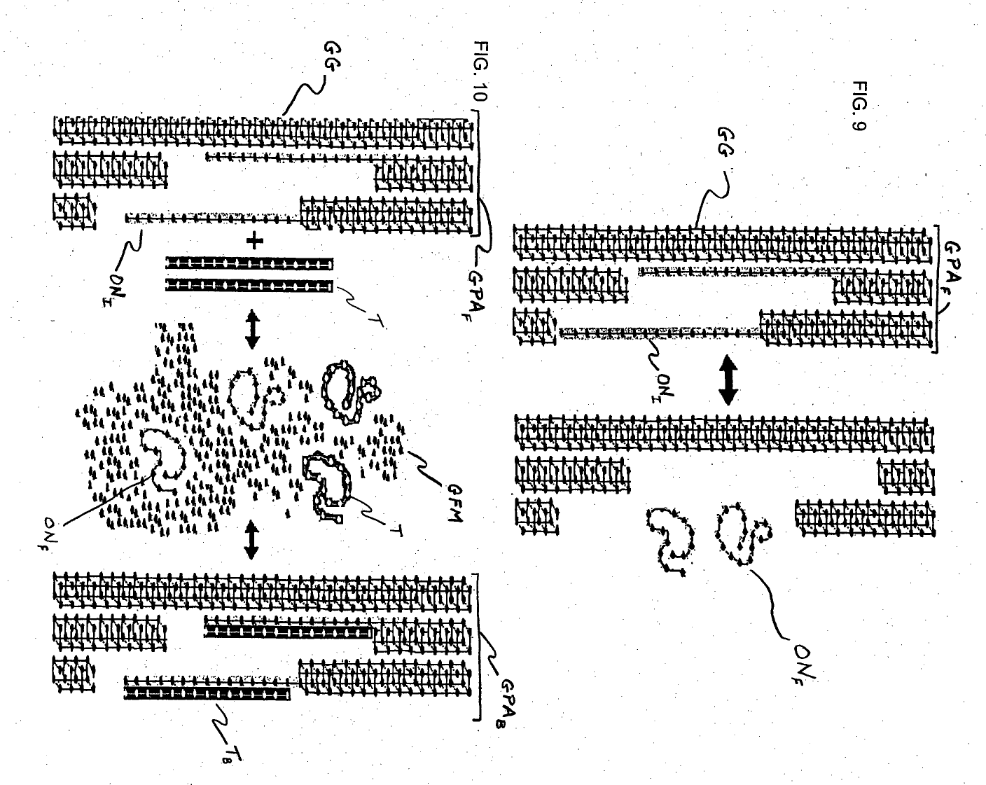

FIG. 9 depicts schematically the reversible incorporation of oligonucleotides that have been extended at one end to include a string of guanines into the gel backbone. FIG. 9 shows on the left formed G-gel GG with incorporated oligonucleotide ON_{I} to provide gel-probe nucleic acid assembly GPA_{F}. Under appropriate conditions, the oligonucleotide can be dissociated from the G-gel to produce free oligonucleotide ON_{F}. The oligonucleotide is designed to include a consecutive stretch of nucleotides that hybridizes to a nucleic acid molecule of interest under the conditions of the CE run, particularly with regard to the temperature of the run and the concentration of monovalent cation present in the mobile phase. To the 5′ or 3′ end of the oligonucleotide is added a stretch of guanines, which allows the hybridization probe to integrate into the gel backbone through formation of G-tetrads that are the basis of G-quartet structures with the GFM. Release would occur upon increasing the temperature above the melting point of the G-quartet structures, which exhibit reversible gelation.

### Example 12

### Hybridization of a Target Nucleic Acid to a G-gel

G-gels that contain nucleic acids that hybridize to nucleic acid molecules of interest are used to detect the presence of and/or purify those nucleic acid molecules of interest by employing a basic strategy schematically outlined in FIG. 10.

G-gels are formed containing single stranded regions that are predicted to hybridize to a nucleic acid molecule of interest. FIG. 10 schematically depicts hybridization of target nucleic acid T to probe nucleic acid ON_{I} that has been incorporated into G-gel GG. In the left panel of FIG. 10, target nucleic acid T is added to gel-probe nucleic acid assembly GPA_{F}. The mixture is raised to a temperature above the melting temperature of the gel to facilitate a homogenous distribution of the probe (depicted as free oligonucleotide ON_{F}) and target nucleic acid T throughout gel forming material GFM. See FIG. 10, middle panel. The system is then cooled to a temperature at which both gelation and hybridization occur. See FIG. 10, right panel. Under appropriate conditions, target nucleic acid T hybridizes to probe nucleic acid T_{B}, which after gelation will form bound gel-probe nucleic acid assembly GPA_{B}. It should be noted that if the melting temperature of the double-stranded nucleic acid is lower than the gelation temperature of the gel, then the target nucleic acid can subsequently be released from the probe, leaving the gel-probe assembly free to participate in another round of hybridization. This “on-off” approach can potentially be repeated indefinitely.

### Example 13

### G-gel Capture and Release of a Target Analyte

G-gels containing an aptamer designed to bind to a target analyte are produced and used for purification and/or detection of the presence of the target analyte. A G-gel containing the aptamer is formed in a capillary or on a microfluidics chip, and a mixture suspected to contain the target analyte is introduced into the matrix. The separation is run under standard conditions until any unbound material present in the mixture has run through the matrix. Any bound target analyte is then recovered under one of two general conditions.

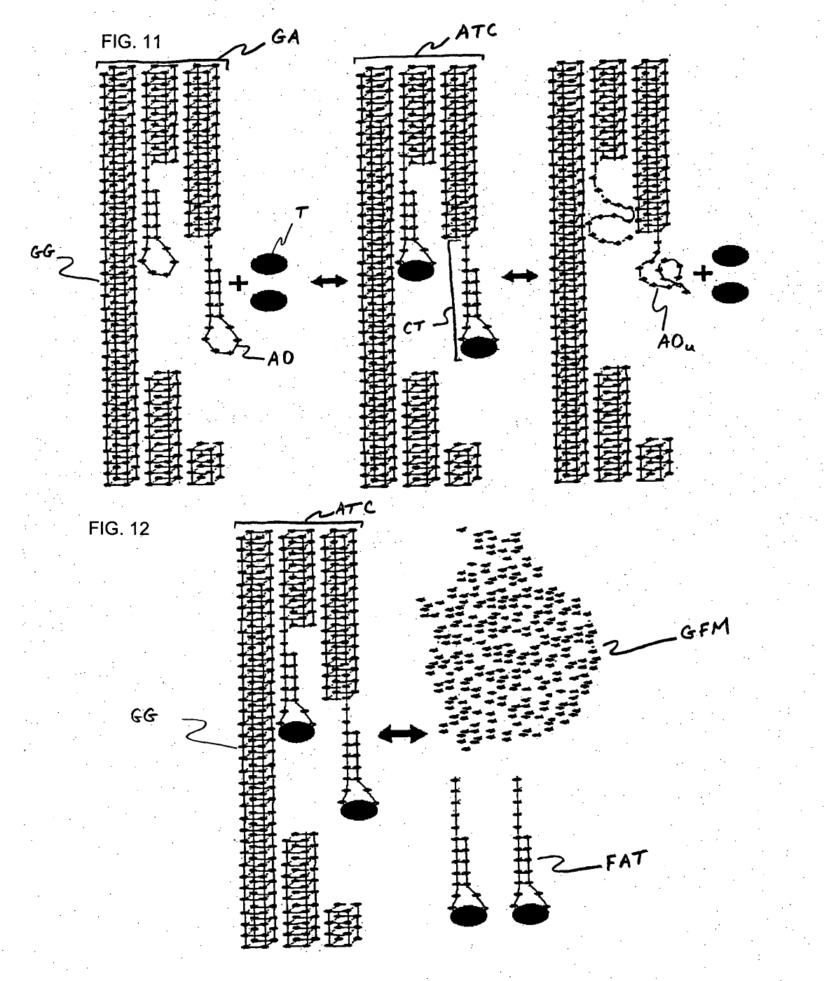

FIG. 11 schematically depicts the situation where the melting temperature of the aptamer conformation is below that of the gel. Initially, target T is introduced into G-gel/aptamer complex GA under conditions sufficient for binding of target T to the complex to form aptamer/target complex ATC. The temperature is then raised above the melting temperature of the aptamer but below the melting temperature of the gel. In this situation, captured target CT can be released from unfolded aptamer AO_{U}, which remains in the gel. G-gel/aptamer complex GA can be reformed by lowering the temperature below the melting temperature of the aptamer, resulting in the refolding of aptameric oligonucleotide AO and regeneration of G-gel/aptamer complex GA.

FIG. 12 schematically depicts the situation where the gel melts below the melting temperature of the aptamer conformation. In this case, intact aptamer-target complex ATC can be released by raising the temperature of G-gel GG to above its melting temperature, but below the melting temperature of aptamer-target complex ATC. After release, aptamer-target complex ATC can be isolated away from gel-forming material GFM as free aptamer/target FAT, and the aptamer can be thermally unfolded to release the target.

### References

The references listed below as well as all references cited in the specification are incorporated herein by reference to the extent that they supplement, explain, provide a background for or teach methodology, techniques, and/or compositions employed herein.

Armstrong D W, Rundlett K & Reid G L 3rd (1994) Use of a macrocyclic antibiotic, rifamycin B, and indirect detection for the resolution of racemic amino alcohols by CE. Anal Chem 66:1690-1695.

Ausubel F M, Brent R, Kingston R E, Moore D D, Seidman J G, Smith J A & Struhl K, eds (1992) Current Protocols in Molecular Biology. Wiley, New York, N.Y., United States of America.

Camilleri P (1993) Capillary Electrophoresis: Theory and Practice. CRC Press, Boca Raton, Fla., United States of America.

Chantot J F, Sarocchi M-T & Guschlbauer W (1971) Physico-Chemical Poperties of Nucleosides. Biochimie 53:347-354.

Drossman H, Luckey J A, Kostichka A J, D'Cunha J & Smith L M (1990) High-Speed Separations of DNA Sequencing Reactions by Capillary Electrophoresis. Anal Chem 62:900-903.

Eggers M, Hogan M, Reich R K, Lamture J, Ehrlich D, Hollis M, Kosicki B, Powdrill T, Beattie K, Smith S & et al. (1994) A Microchip for Quantitative Detection of Molecules Utilizing Luminescent and Radioisotope Reporter Groups. Biotechniques 17:516-525.

Gellert M, Lipsett M N & Davies D R (1962) Helix Formation by Guanylic Acid. Proc Natl Acad Sci USA 48:2013.

Grossman P D & Colburn J C (1992) Capillary Electrophoresis: Theory and Practice. Academic Press, San Diego, Calif., United States of America.

Guschlbauer W, Chantot J F & Thiele D (1990) FouD-Stranded Nucleic Acid Structures 25 Years Later: From Guanosine Gels to Telomer DNA. J Biomol Struct Dyn 8:491-511.

Huang X C, Quesada M A & Mathies R A (1992) DNA Sequencing Using Capillary Array Electrophoresis. Anal Chem 64:2149-2154.

Lamture J B, Beattie K L, Burke B E, Eggers M D, Ehrlich D J, Fowler R, Hollis M A, Kosicki B B, Reich R K, Smith S R & et al. (1994) Direct Detection of Nucleic Acid Hybridization on the Surface of a Charge Coupled Device. Nucleic Acids Res 22:2121-2125.

Liu Z, Zou H, Ye M, Ni J & Zhang Y (1999) Effects of organic modifiers on solute retention and electrokinetic migrations in micellar electrokinetic capillary chromatography. Electrophoresis 20:2898-2908.

Mariani P, Ciuchi F & Saturni L (1998) Helix-specific interactions induce condensation of guanosine four-stranded helices in concentrated salt solutions. Biophys J 74:430-5.

Marsh T C & Henderson E (1994) G-Wires: Self-Assembly of a Telomeric Oligonucleotide, D(Ggggttgggg), into Large Superstructures. Biochemistry 33:10718-10724.

Newton C R, Holland D, Heptinstall L E, Hodgson I, Edge M D, Markham A F & McLean M J (1993) The Production of Pcr Products with 5′ Single-Stranded Tails Using Primers That Incorporate Novel Phosphoramidite Intermediates. Nucleic Acids Res 21:1155-1162.

Nikiforov T T & Rogers Y H (1995) The Use of 96-Well Polystyrene Plates for DNA Hybridization-Based Assays: An Evaluation of Different Approaches to Oligonucleotide Immobilization. Anal Biochem 227:201-209.

Rasmussen S R, Larsen M R & Rasmussen S E (1991) Covalent Immobilization of DNA onto Polystyrene Microwells: The Molecules Are Only Bound at the 5′ End. Anal Biochem 198:138-142.

Running J A & Urdea M S (1990) A Procedure for Productive Coupling of Synthetic Oligonucleotides to Polystyrene Microtiter Wells for Hybridization Capture. Biotechniques 8:276, 279.

Sambrook J & Russell D W (2001) Molecular Cloninq: A Laboratory Manual, 3rd ed. Cold Spring Harbor Laboratory Press, Cold Spring Harbor, N. Y., United States of America.

Seller K, Fan Z H, Fluri K & Harrison D J (1994) Electroosmotic Pumping and Valveless Control of Fluid within a Manifold of Capillaries on a Glass Chip. Anal Chem 66:3485-3491.

Swerdlow H & Gesteland R (1990) Capillary Gel Electrophoresis for Rapid, High Resolution DNA Sequencing. Nucleic Acids Res 18:1415-1419.

Walmsley J A & Burnett J F (1999) A new model for the K+-induced macromolecular structure of guanosine 5′-monophosphate in solution. Biochem 38:14063-8.

Ward T J, Dann C 3^{rd} & Blaylock A (1995) Enantiomeric resolution using the macrocyclic antibiotics rifamycin B and rifamycin SV as chiral selectors for capillary electrophoresis. J Chromatogr A 715:337-44.

Williams P E (1992) Methods 4:227-232.

Zhang Y, Coyne M Y, Will S G, Levenson C H & Kawasaki E S (1991) Single-Base Mutational Analysis of Cancer and Genetic Diseases Using Membrane Bound Modified Oligonucleotides. Nucleic Acids Res 19:3929-3933.

It will be understood that various details of the presently disclosed subject matter can be changed without departing from the scope of the presently disclosed subject matter. Furthermore, the foregoing description is for the purpose of illustration only, and not for the purpose of limitation.

What is claimed is:

1. A capillary electrophoresis and electrochromatography matrix comprising a gel comprising one or more G-quartet forming nucleosides, oligonucleotides, or combinations thereof, wherein the gel comprises a monolithic form.

2. The matrix of claim 1, wherein the one or more G-quartet forming nucleosides, oligonucleotides, or combinations thereof are present on a microfluidics device.

3. The matrix of claim 1, wherein the matrix further comprises an enzyme.

4. A capillary electrophoresis and electrochromatography matrix comprising beads embedded in a gel comprising one or more G-quartet forming nucleosides, oligonucleotides, or combinations thereof.

5. The matrix of claim 4, wherein the beads are chromatography packing beads.

6. The matrix of claim 4, wherein the beads are functionalized.

7. The matrix of claim 6, wherein the beads are functionalized with a protein, an oligonucleotide, or a combination thereof.

8. The matrix of claim 4, wherein the gel comprises a monolithic form.

9. The matrix of claim 4, wherein the one or more G-quartet forming nucleosides, oligonucleotides, or combinations thereof are present on a microfluidics device.

10. A capillary electrophoresis and electrochromatography column comprising a matrix comprising a gel comprising one or more G-quartet forming nucleosides, oligonucleotides, or combinations thereof and a support.

11. The column of claim 10, wherein the gel comprises a monolithic form.

12. The column of claim 10, wherein the matrix further comprises an enzyme.

13. A method of isolating a target analyte from a mixture, the method comprising:
(a) contacting a mixture known or suspected to comprise a target analyte with a matrix comprising a gel comprising one or more G-quartet forming nucleosides, oligonucleotides, or combinations thereof; and
(b) eluting the target analyte from the matrix.

14. The method of claim 13, wherein the gel comprises a monolithic form.

15. The method of claim 13, wherein the one or more G-quartet forming nucleosides, oligonucleotides, or combinations thereof are present on a microfluidics device.

16. The method of claim 13, wherein the matrix comprises beads embedded in the gel comprising G-quartet forming nucleosides, oligonucleotides, or combinations thereof.

17. The method of claim 16, wherein the beads are chromatography packing beads.

18. The method of claim 17, wherein the beads are functionalized.

19. The method of claim 18, wherein the beads are functionalized with a protein, an oligonucleotide, or a combination thereof.

20. The method of claim 13, wherein the matrix further comprises an enzyme.

21. A method of detecting a target analyte in a mixture, the method comprising:
(a) contacting a mixture known or suspected to comprise a target analyte with a matrix comprising a gel comprising one or more G-quartet forming nucleosides, oligonucleotides, or combinations thereof;
(b) washing the matrix under conditions sufficient to remove non-specifically bound material; and
(c) detecting the target analyte bound to the matrix.

22. The method of claim 21, wherein the target analyte is a nucleic acid present within the genome of a microbe.

23. The method of claim 21, wherein the gel comprises a monolithic form.

24. The method of claim 21, wherein the matrix further comprises an enzyme.

25. The method of claim 21, further comprising lysing a cell that comprises the target analyte.

26. The method of claim 21, wherein one or more G-quartet forming nucleosides, oligonucleotides, or combinations thereof are present on a microfluidics device.

27. A microfluidics device comprising one or more G-quartet forming nucleosides, oligonucleotides, or combinations thereof.

28. The device of claim 27, wherein the one or more G-quartet forming G-quartet forming nucleosides, oligonucleotides, or combinations thereof are disposed in a channel present on the device.

29. A microfluidics system comprising a microfluidics device of claim 27.

30. A method of transporting a reagent on a microfluidics device, the method comprising:
(a) providing a microfluidics device comprising one or more G-quartet forming nucleosides, oligonucleotides, or combinations thereof;
(b) contacting the microfluidics device with the reagent; and
(c) applying a force to the microfluidics device to transport the reagent on the microfluidics device.

31. The method of claim 30, wherein the one or more G-quartet forming nucleosides, oligonucleotides, or combinations thereof are disposed in a channel present on the device.

32. The method of claim 30, wherein the force is provided by a pump or by an electrical current.

33. The method of claim 30, wherein the reagent is a nucleic acid molecule.
